(19) United States
(12) Patent Application Publication
(10) Pub. No.: US 2025/0002178 A1
(43) Pub. Date: Jan. 2, 2025

(54) Systems and Methods for Cloud Avoidance

(71) Applicant: Planet Labs PBC, San Francisco, CA (US)

(72) Inventors: Kiruthika Devaraj, Sunnyvale, CA (US); Shreeyam Kacker, San Francisco, CA (US)

(21) Appl. No.: 18/345,883

(22) Filed: Jun. 30, 2023

(51) Int. Cl. B64G 1/24; B64G 1/36; G05D 1/10; G06T 5/00; G06T 5/20; G06T 7/11; G06T 7/246

(52) U.S. Cl. CPC B64G 1/244; B64G 1/36; G06T 5/20; G06T 5/70; G06T 7/11; G06T 7/248; G06T 2207/10016; G06T 2207/20076; G06T 2207/20084; G06T 2207/20161; G06T 2207/30241

(57) ABSTRACT

Systems and methods for cloud avoidance are presented. For example, a computing system may be configured to obtain image data from a forward-looking sensor of a satellite, wherein the satellite is traveling along a current trajectory. The computing system may be configured to determine, using a model and based on the image data, an imaging target and cloud coverage associated with the imaging target. The computing system may be configured to determine a comparison between the cloud coverage associated with the imaging target and a threshold level of cloud coverage. The computing system may be configured to determine an updated trajectory for the satellite based on the current trajectory and the comparison. The computing system may be configured to generate one or more command instructions to control a motion of the satellite based on the updated trajectory.

### FIELD

The present disclosure relates generally to techniques to avoid clouds on slew trajectories of satellites. More particularly, the present disclosure relates to systems and methods for avoiding cloud cover using a forward-looking sensor and a model to determine target geographic regions along a trajectory of a satellite.

### BACKGROUND

A constellation of imaging satellites can be utilized to acquire imagery. The satellites can be controlled to acquire the imagery by, for example, a ground-based control center. The control center can uplink commands to the satellites and receive imagery via a satellite downlink.

### SUMMARY

Aspects and advantages of embodiments of the present disclosure will be set forth in part in the following description, or can be learned from the description, or can be learned through practice of the embodiments.

One example embodiment of the present disclosure is directed to a computing system of a satellite. The computing system includes one or more sensors including a forward-looking sensor. The computing system includes one or more processors and one or more tangible, non-transitory, computer-readable media storing instructions executable by the one or more processors cause the computing system to perform operations. The operations include obtaining image data from the forward-looking sensor of the satellite, wherein the satellite is traveling along a current trajectory. The operations include determining, using a model and based on the image data, an imaging target and cloud coverage associated with the imaging target. The operations include determining a comparison between the cloud coverage associated with the imaging target and a threshold level of cloud coverage. The operations include determining an updated trajectory for the satellite based on the current trajectory and the comparison between the cloud coverage associated with the imaging target and the threshold level of cloud coverage.

The operations include generating one or more command instructions to control a motion of the satellite based on the updated trajectory.

In some implementations, the operations include accessing metadata associated with one or more environmental conditions.

In some implementations the example metadata includes at least one of (i) a sensor temperature, (ii) a sun angle, (iii) an earth surface angle, or (iv) a slew angle.

In some implementations, the operations include receiving a request for imagery of a geographic region, the request for imagery associated with the imaging target and the threshold level of cloud coverage.

In some implementations, the operations include determining, based on the current trajectory, a probability of the satellite passing over the imaging target. In some implementations, the operations include determining an updated imaging target based on the probability.

In some implementations the example model is a convolutional neural network.

In some implementations, the one or more sensors includes at least one of (i) a VIS camera, or (ii) a LWIR camera.

In some implementations the updated trajectory is a slew trajectory.

Another example embodiment of the present disclosure is directed to a computer-implemented method. The method includes obtaining image data from one or more sensors of a satellite including a forward-looking sensor, wherein the satellite is traveling along a current trajectory. The method includes determining, using a model and based on the image data, an imaging target and cloud coverage associated with the imaging target. The method includes determining a comparison between the cloud coverage associated with the imaging target and a threshold level of cloud coverage. The method includes determining an updated trajectory for the satellite based on the current trajectory and the comparison between the cloud coverage associated with the imaging target and the threshold level of cloud coverage. The method includes generating one or more command instructions to control a motion of the satellite based on the updated trajectory.

In some examples, the method includes accessing metadata associated with one or more environmental conditions.

In some examples, the metadata includes at least one of (i) a sensor temperature, (ii) a sun angle, (iii) an earth surface angle, or (iv) a slew angle.

In some examples, the method includes receiving a request for imagery of a geographic region, the request for imagery associated with the imaging target and the threshold level of cloud coverage.

In some examples, the method includes determining, based on the current trajectory, a probability of the satellite passing over the imaging target. In some examples, the method includes determining an updated imaging target based on the probability.

In some examples, the method includes controlling the motion of the satellite to pass over the imaging target, wherein passing over the imaging target is indicative of a nadir position or an off-nadir position. In some examples, the method includes obtaining, using a sensor of the one or more sensors, imagery of the imaging target.

In some examples, the model is a convolutional neural network.

In some examples, the one or more sensors includes at least one of (i) a VIS camera, or (ii) a LWIR camera.

In some examples, the updated trajectory is a slew trajectory.

Another example embodiment of the present disclosure is directed to a non-transitory, computer-readable media storing instructions executable by the one or more processors cause the computing system to perform operations. The operations include obtaining image data from a forward-looking sensor of a satellite, wherein the satellite is traveling along a current trajectory. The operations include determining, using a model and based on the image data, an imaging target and cloud coverage associated with the imaging target. The operations include determining a comparison between the cloud coverage associated with the imaging target and a threshold level of cloud coverage. The operations include determining an updated trajectory for the satellite based on the current trajectory and the comparison between the cloud coverage associated with the imaging target and the threshold level of cloud coverage. The operations include generating one or more command instructions to control a motion of the satellite based on the updated trajectory.

Yet another example embodiment is directed to a computer-implemented method.

The method includes obtaining image data from a forward-looking sensor of a satellite. The method includes determining, using a model and based on the image data, an imaging target and cloud coverage associated with the imaging target. The method determining an imaging target and cloud coverage associated with the imaging target includes analyzing, using the model, an image frame of the image data. The method determining an imaging target and cloud coverage associated with the imaging target includes generating, using the model, a plurality of image segments, wherein the plurality of image segments is associated with one or more clouds depicted in the image frame. The method determining an imaging target and cloud coverage associated with the imaging target includes generating, using the model, a plurality of blurred image segments, wherein the plurality of blurred image segments are indicative of cloud characteristics. The method includes determining, using the model, the cloud coverage associated with respective blurred image segments of the plurality of blurred image segments.

In some examples, the method includes determining a comparison between the cloud coverage associated with the imaging target a threshold level of cloud coverage. In some examples, the method includes determining an updated trajectory for the satellite based on a current trajectory and the comparison between the cloud coverage associated with the imaging target and the threshold level of cloud coverage.

Other aspects of the present disclosure are directed to various methods, systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example satellite system according to example embodiments of the present disclosure;

FIGS. 2A-2B depicts an example satellite including sensors according to example aspects of the present disclosure;

FIG. 3 depicts a block diagram of an example data pipeline according to example aspects of the present disclosure;

FIG. 4 depicts example image processing according to example aspects of the present disclosure;

FIG. 5 depicts an example flow diagram of an example method for recomputing targets according to example aspects of the present disclosure;

FIG. 6 depicts an example maneuvering plan according to example aspects of the present disclosure;

FIG. 7A-B depicts flowchart diagrams of example methods according to example aspects of the present disclosure; and

FIG. 8 depicts example system components according to example aspects of the present disclosure.

### DETAILED DESCRIPTION

Example aspects of the present disclosure are directed to techniques for avoiding cloud coverage for images taken by a satellite. For example, a satellite operator (i.e., a company, government agency, etc.) may utilize imagery satellites to capture images of geographic regions on earth upon request. A requesting company or individual may request that satellite images be captured of a specific geographic region, for which a payload sensor may be positioned on board the satellite to capture the desired image of the specific geographic region. Among other factors contributing to the quality or useability of the captured image, the requirements of the image may include a threshold level of tolerance of cloud coverage, which may obstruct visibility of portions of the Earth's surface. For instance, clouds may obscure or block the desired imagery, or portions thereof. The satellite operator may assign the request to one or more satellites orbiting earth, which may have a trajectory that passes over or near the geographic region associated with the request, such that the payload sensor may be positioned to capture the desired image. In some examples, the assigned satellites may have instruments used to calculate or determine that the geographic region associated with the request is covered with clouds and fails to satisfy the threshold indicated by the request. For instance, sensor data processed by the satellite may indicate the presence of cloud coverage. In some examples, cloud coverage above or below the defined threshold may result in images that do not satisfy the request. According to example aspects of the present disclosure, satellites may utilize a plurality of sensors, metadata, and models to avoid capturing cloud-obstructed images by generating imaging targets that include cloud coverage characteristics which satisfy the defined thresholds.

For example, a cloud avoidance model running on-board a satellite may receive input sensor data, metadata, and/or trajectory data to determine one or more imaging targets where cloud cover is below or above a defined threshold (e.g., a tolerable level/percentage of cloud coverage in a given geographic area). Sensor data may include images or other data captured by one or more cameras or sensors on board the satellite.

Example sensors may include a VIS (visible imaging system) sensor, a LWIR (longwave infrared) sensor, or other types of sensors or cameras. In some examples, the satellite may include a forward-looking sensor. A forward-looking sensor may include one or more cameras which are positioned in a forward angle from nadir. Nadir is the point directly below the satellite relative to the Earth. For instance, the forward-looking sensor may be positioned +25 degrees relative to nadir. In some examples, the forward-looking sensor may allow the satellite to receive sensor data indicative of a potential path of travel for the satellite. The +25 degree angle may include a field of view ahead of the satellite such that the satellite may process sensor data within a time frame sufficient to adjust the trajectory of the satellite. For example, +25 degree angle may be calibrated such that sensor data obtained by the satellite is usable (e.g., not outdated). In some examples, a greater degree angle (e.g., +50, +60, etc.) may allow for a time frame sufficient to adjust the trajectory of the satellite, but may also allow for conditions to change. For instance, clouds may form or change position between the time sensor data is captured and processed by the satellite and an updated trajectory reaches a potential imaging target. Additionally, or alternatively, a lesser angle (e.g., +15, +10, etc.) may provide more up-to-date prediction of the location and structure of clouds, but may not allow for suitable processing time for the satellite to process the sensor data from the forward-looking sensor and make any adjustments to the trajectory of the satellite. The angles relative to nadir used herein are illustrative in nature based on current satellite capability limitations, such as in processing speed, power consumption, and positioning systems. It is contemplated that as such satellite capabilities continue to improve, that an angle of less than +25 degrees may be desirable.

Satellites may also utilize metadata for cloud avoidance modeling. The metadata may include data such as the camera temperature, sun angle, Earth surface angle, or slew angle.

For instance, the metadata may indicate additional information which may impact the accuracy of the sensor data or trajectory data. The trajectory data may include a current slew trajectory of the satellite. For instance, the current slew trajectory may include the satellite's current orientation or movement in reference to its orbit track. In some examples, the current slew trajectory is associated with a path of travel that will pass over geographic regions (e.g., imaging targets) scheduled for image acquisition by the satellite.

The cloud avoidance model may process the sensor data and metadata to generate imaging targets which satisfy respective thresholds for cloud coverage. The satellite may generate an updated trajectory to avoid imaging targets which are covered by clouds. For instance, the cloud avoidance model may fuse the sensor data and metadata to allow for more accurate image data that compensates for environmental factors. Environmental factors may distort the sensor data and result in an inaccurate determination of cloud coverage. For example, sensor data may include a plurality of image frames. In some examples, the cloud avoidance model may perform segmentation to segment the image frames fused with the metadata based on clouds or other objects detected in the image frames. The cloud avoidance model may detect a plurality of clouds in an image frame and segment the image frame to encapsulate the respective clouds. In some examples, the cloud avoidance model may segment the image frames fused with metadata based on imaging targets. The cloud avoidance model may encapsulate the respective geographic region and further segment based on detected objects such as clouds. In some examples, the cloud avoidance model may project a blur box onto the segmented image frame. A blur box may be projected in 5 km increments, 10 km increments, etc., and blur the image segment. In some examples, blurring the image segment reduces the number of features that are needed to process the image frame by the cloud avoidance model.

The cloud avoidance model may analyze the blurred image segment and determine, based on its features, the presence of clouds. In some examples, the cloud avoidance model may output one or more imaging targets (e.g., requested imagery of geographic regions) which do not contain cloud coverage or that satisfy a defined threshold for cloud coverage. For instance, the cloud avoidance model may determine the presence of clouds in a requested geographic region is below a defined threshold and determine an imaging target to cause a satellite system to generate command instructions to update the trajectory of the satellite such that the satellite passes over the geographic region (e.g., imaging target). In some examples, a flight control system of the satellite may determine that the satellite will not pass over the one or more targets based on a current trajectory and the cloud avoidance model may recompute the imaging targets and determine updated imaging targets. In some examples, the updated imaging target may cause satellite system to generate command instructions to update the trajectory of the satellite such that the satellite will pass over the updated imaging targets.

The technology of the present disclosure may provide several benefits and technical effects. For instance, the technology of the present disclosure may optimize the trajectory of satellites tasked to perform satellite imagery by avoiding clouds to capture a higher percentage of usable satellite imagery and decreasing the number of orbits which yield unusable satellite imagery. As such, the technology may increase the flexibility of the satellite by allowing more agile trajectory generation that targets geographic regions which contain tolerable cloud coverage. The technology of the present disclosure may also help to increase the efficiency and management of a satellite system due to the blurring of image segments which reduce the number of features the cloud avoidance model must learn to detect and predict cloud coverage, thereby preserving limited power and computing resources. Moreover, by blurring image segments, the technology of the present disclosure may decrease the computing resources required to process sensor data and avoid the presence of clouds.

The technology of the present disclosure also improves the onboard computing technology of the satellite. For instance, the satellite may include limited power and computing resources to continuously operate the satellite throughout its lifetime. The model running on satellite system may obtain image data from the forward-looking sensor and fuse the image data with the metadata to produce more accurate input data for the model and improve the confidence level of the model. The model may segment the image data fused with the image data and generate a box blur to blur the image segments. This may include blurring features of objects such as clouds depicted in the image segment. In this way, the model is limited in the number of features it must learn to detect the absence of clouds in an image frame. Accordingly, the satellite system can avoid wasting computing resources to power the model by more efficiently learning cloud features and processing image frames to the detect the absence of clouds. In this way, the satellite computing system can more efficiently utilize its computing resources.

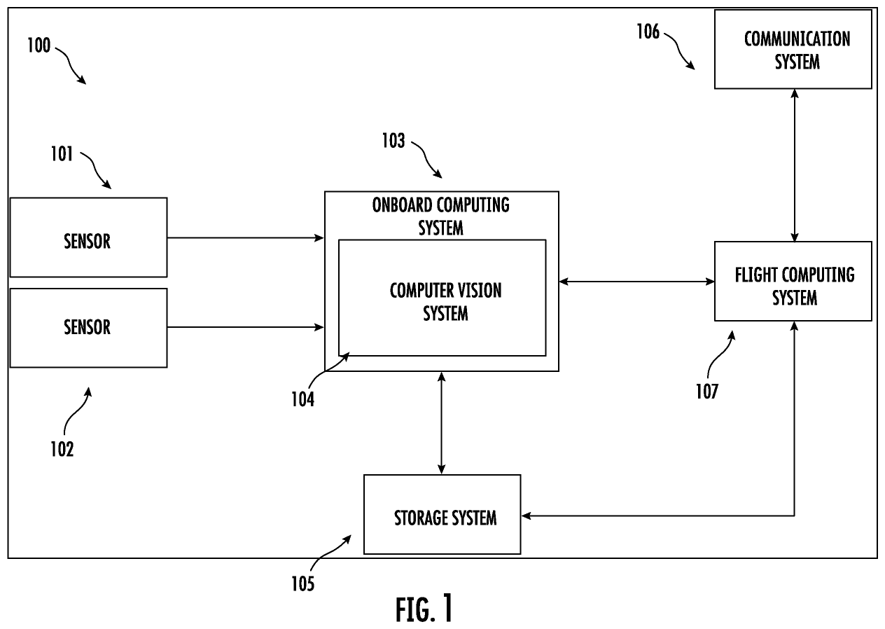

With reference now to the FIGS., example embodiments of the present disclosure will be discussed in further detail. FIG. 1 depicts an example satellite system according to example embodiments of the present disclosure. The satellite system 100 may include a number of subsystems and components for performing various operations. For example, the satellite system 100 may include sensors 101, 102, an onboard computing system 103, onboard storage system 105, a flight computing system 107, and a communication system 106. The satellite system 100 may be any computing device which is capable of exchanging data and sharing computing resources. For example, the satellite system 100 may include one or more devices configured to receive, store, or transmit data over physical or wireless technologies. In some examples, the satellite system 100 may include hardware and software. In other examples, the satellite system 100 may include physical devices connected to one or more networks. In some examples, the satellite system 100 may be any type of satellite (e.g., low earth orbit satellites, medium earth orbit satellites, polar orbit satellites, etc.,) which orbits the Earth and is capable of acquiring imagery.

The satellite system 100 may include sensors 101, 102. In some examples, the sensors 101, 102 may be cameras. For example, sensor 101 may be a VIS (visible imaging sensor) camera. A VIS camera may include a standard video camera packaged for flight use mounted in a downward oriented manner to provide a continuous view of geographic regions directly below the satellite. Sensor 102 may be a LWIR (long wave infrared) camera. A LWIR camera may include cameras capable of thermal imaging. While examples here describe the sensors 101, 102 as a VIS camera and a LWIR camera, the sensors 101, 102 may include additional types of cameras such as NIR (near-infrared), SWIR (short-wave infrared), MWIR (mid-wave infrared), etc. In some examples, sensors 101, 102 may be a combination of sensors described herein.

In some examples, the satellite system 100 may include an onboard computing system 103. For instance, the sensors 101, 102 may be connected to the onboard computing system 103. In some examples, the sensors 101, 102 may be connected via a USB (universal serial bus). In some examples, the sensors 101, 102 may be connected via a MIPI (mobile industry processor interface) interface. For example, a MIPI interface may include a camera module or system which transmits an image from the sensors 101, 102 and stores the image in memory (e.g., storage system 105) as individual frames. In other examples, the sensors 101, 102 may be connected to the onboard computing system 103 via any wired or wireless connection such as Bluetooth, SDIO, USB-A, USB-C, etc.

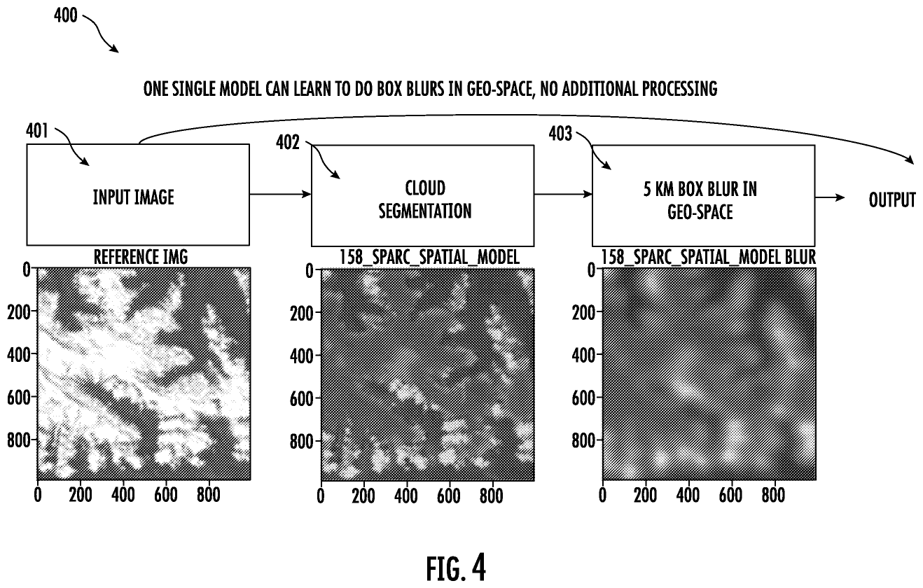

The onboard computing system 103 may include a number of subsystems and components for performing various operations. For example, the onboard computing system 103 may include a computer vision system 104. The computer vision system 104 may include any computing device which is capable of running computer vision applications. For instance, the computer vision system 104 may include one or more devices configured to perform tasks such as image classification, image segmentation, object detection, etc. In some examples, the computer vision system 104 may include hardware and software. For instance, the computer vision system 104 may include models which process sensor data captured by the sensors 101, 102. An example of the computer vision system 104 processing sensor data is further described with reference to FIGS. 3-4.

The satellite system 100 may include a storage system 105. For instance, the onboard computing system 103 may be connected to the storage system 105. The storage system 105 may include one or more storage devices for storing data. For example, the storage system 105 may include an electronic storage device, a magnetic storage device, an optical storage device, an electromagnetic storage device, a semiconductor storage device, or any suitable combination for storing data. In some examples, the onboard computing system 103 may be connected to the storage system 105 via a wired or wireless connection. For instance, the onboard computing system 103 may be connected to the storage system 105 via an ethernet cable. In some examples, the onboard computing system 103 and storage system 105 may be connected via a Gigabit Ethernet cable. In other examples, the onboard computing system 103 and storage system 105 may be connected over a wireless connection such as Bluetooth, SDIO, etc.

The onboard computing system 103 may transmit and store data in the storage system 105 over a connection (e.g., ethernet, Gig Ethernet, etc.). By way of example, the sensors 101, 102 may receive sensor data and transmit the sensor data over one or more connections to the onboard computing system 103. In some examples, the computer vision system 104 may perform one or more computer vision tasks and transmit the processed sensor data to the storage system 105 for storage. For instance, the storage system 105 may include data stores such as relational databases, non-relational databases, key-value stores, full-text search engines, message queues, etc. In some examples, the computer vision system 104 may store and retrieve data within the storage system 105 over a wired or wireless connection.

In some examples, the storage system 105 may store data associated with one or more satellites in a satellite constellation. Data associated with the satellites may include a schedule indicative of the pending image acquisition commands/sequences of a given satellite or group of satellites. In some examples, the data associated with satellite may include data indicative of the past, present, and/or future trajectory of the satellite(s). In some examples, the data associated with the satellites may include information associated with the power resources (e.g., power level, etc.), memory resources (e.g., storage availability, etc.), communication resources (e.g., bandwidth), etc. of the satellite(s). In some examples, the data associated with the satellites may include health and maintenance information associated with the satellite(s) (e.g., maintenance schedules, damage reports, other status reports, etc.). In other examples, the data associated with the satellite may include data indicative of the type and/or status of the hardware (e.g., antenna, communication interfaces, etc.) and/or software onboard a satellite (e.g., satellite system 100).

The satellite system 100 may include a flight computing system 107. For instance, the onboard computing system 103 and flight computing system 107 may transmit data over one or more wired or wireless connections such as Ethernet, Bluetooth, etc. The flight computing system 107 may include different subsystems, software, and hardware for performing various flight control operations. For example, the subsystems may include flight controllers for controlling a motion of the satellite system 100. Example flight controllers may include propulsion thrusters, reaction wheels, etc. By way of example, the flight computing system 107 may receive electrical signals over one or more connections from the onboard computing system 103. For instance, the flight computing system 107 may be configured to implement translated controls (e.g., electrical signals) from the onboard computing system 103. In some examples, the flight computing system 107 may implement operations to flight controllers of the satellite system 100 to adjust a trajectory of the satellite.

In some examples, the flight computing system 107 may include satellite flight software and an execution model to support a communication pathway with the communication system 106. In some examples, the flight computing system 107 may include software to support hardware in a translation layer (e.g., providing a highly efficient packet protocol), a commanding interface to utilize a low bandwidth channel (e.g., 10s bits/second), an interface to sequence loading, module(s) for attitude control system (ACS) target tracking, a module for image (IMG) captures, module(s) for emergency commanding, module(s) for real time telemetry feedback for critical satellite states module(s) for providing the ability to change pathway settings autonomously based on position (e.g., GPS, etc.) and a specific geostationary satellite footprint that has the best line-of-sight (LOS) for the satellite system 100 to encode/decode data transmitted via the communication system 106, etc.

In some examples, the flight computing system 107 may transmit data over one or more connections to the onboard computing system 103. For instance, data such as health and maintenance information associated with the flight computing system 107 may be transmitted to the onboard computing system 107. In some examples, the data such as the current trajectory of the satellite may be transmitted to the onboard computing system 103. By way of example, the flight computing system 107 may receive electrical signals to adjust a trajectory of the satellite. The flight computing system 107 may determine the satellite has insufficient power/resources to implement the controls or determine, based on its current trajectory, there is insufficient time to implement the controls. In some examples, the flight computing system 107 may transmit response data indicating the current trajectory of the satellite and resources are insufficient to implement controls.

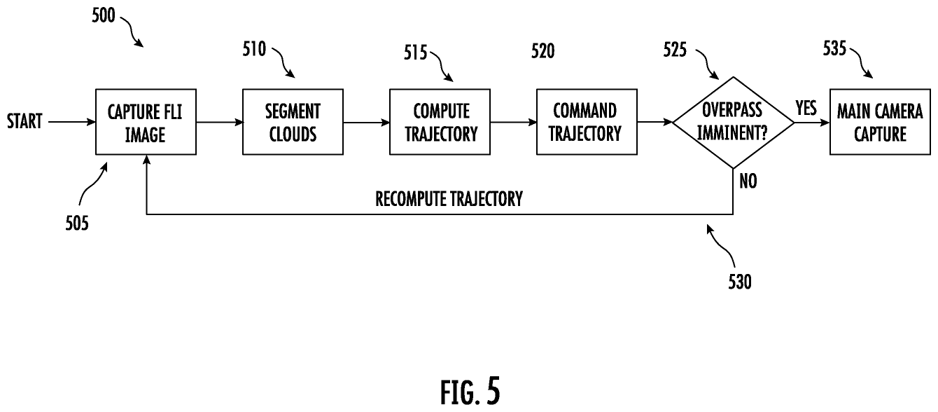

In some examples, the flight computing system 107 may transmit and store data in the storage system 105 over a connection (e.g., ethernet, Gig Ethernet, etc.). For instance, the flight computing system 107 may be connected to the storage system 105 via a wired or wireless connection. By way of example, the flight computing system 107 may receive one or more electrical signals to control a motion of the satellite. The flight computing system 107 may implement the operations and transmit data over the connection to the storage system 105. For instance, the flight computing system 107 may transmit current trajectory data, an updated trajectory of the satellite after adjusting the trajectory of the satellite, etc. In some examples, the data stored in the storage system 105 may also be accessible by the onboard computing system 103. For instance, the onboard computing system 103 may utilize data (e.g., trajectory data) generated by the flight control system 107 and stored in the storage system 105 for processing sensor data to generate updated trajectories for the satellite. An example of the onboard computing system 103 utilizing data generated by the flight computing system 107 to generate updated trajectories is further described with reference to FIG. 5.

The satellite system 100 may include a communications system 106. The communication system 106 may include hardware and software configured to communicate with remote systems and devices. For instance, the communication system 106 may include antennas that allow the communication system to utilize RT (real time/near real time) communication pathways. RT communication pathways may include a communication pathway via which an image acquisition command is sent directly to the satellite system 100. For instance, a signal may be sent from a ground station to the satellite system 100 when the orbital access and pointing/range requirements of that pathway are met (e.g., when the satellite is in an orbit position to receive a transmission from a ground-based command center). In some examples, the antennas may include an omnidirectional antenna that may be configured to close a link for tasking. In some examples, the communication system 106 may include a phased array antenna (e.g., for higher data rates). In other examples, the communication system 106 may include two separate antennas for a forward and/or reverse link.

The communication system 106 may include one or more subsystems. The subsystem may include RF (radio frequency) interfaces to transmit (Tx) and/or receive (Rx) via antennas. In some examples, the communication system 106 may utilize full-duplex operation, such that the receiver is enabled at all times. The communication system 106 may utilize frequency separation f1, f2, etc. (e.g., 6 GHZ/4 GHz Tx/Rx frequency separation) for effective isolation between the receiving (Rx) and transmitting (Tx) paths.

In some examples, the communication system 106 may include GEO communication infrastructure. Example GEO communication infrastructure may include a Very Small Aperture Terminal (VSAT). VSAT may include a two way satellite communication system for communicating with a ground station (e.g., GEO hub(s)) or other satellites such as geostationary satellites. For instance, the communications system 106 may be integrated with a plurality of geostationary satellites with architecture for providing global coverage beams. By way of example, the communications system 106 may establish a network connection for the satellite system 100 by utilizing dedicated bandwidth from geostationary satellites and GEO hub(s). A link may be established to a particular satellite by selecting a corresponding geostationary satellite and GEO hub. As described herein, the GEO hub(s) may be ground stations with communication infrastructure for communication with the geostationary satellites. In some implementations, modems tuned to dedicated frequencies for the entity associated with the communication system 106 may be housed at the GEO hub(s).

In some examples, the communication system 106 may communicate with ground stations and receive a schedule indicative of the pending image acquisition (e.g., imaging targets) commands. For instance, the ground stations may be associated with a control center which receives requests for image acquisition from one or more third parties, directly from the satellite owner, or satellite operator. In some examples, the ground stations may identify a satellite which is available to acquire the requested imagery. In some examples, the ground station may transmit an acquisition command (e.g., radio signal translation, etc.) to the communication system 106.

The communication system 106 may be configured to obtain the image acquisition command (e.g., a radio signal translation, etc.) and transmit electrical signals over one or more connections to the flight computing system 107. For instance, the flight computing system 107 may be configured to implement translated controls (e.g., electrical signals) from the communication system 106. In some examples, the flight computing system 107 may implement operations to adjust a trajectory of the satellite and acquire the images. In some examples, the flight computing system 107 may store a schedule of pending image acquisitions (e.g., image requests) in the storage system 105. For instance, the onboard computing system 105 may access and process the schedule of pending image acquisitions. An example of the onboard computing system processing the schedule of pending image acquisitions is further described with reference to FIG. 3.

In some examples, the communication system 106 may utilize the RT communication pathways to downlink acquired imagery to a ground station. By way of example, the communication system 106 may receive image acquisition commands (e.g., imagery request) from a ground station. The flight computing system 107 may adjust, using flight controllers, the trajectory of the satellite system 100 to navigate to the geographic region specified by the image acquisition command. The sensors 101, 102 may acquire imagery which satisfies the image acquisition command and transmit the imagery to the onboard computing system 103. In some examples, the onboard computing system 103 may store the imagery in the storage system 105. In some examples, the flight computing system 107 may determine that the satellite system 100 is in an orbit position to downlink a transmission to a ground station center and the communication system 106 may downlink the requested imagery to the ground station.

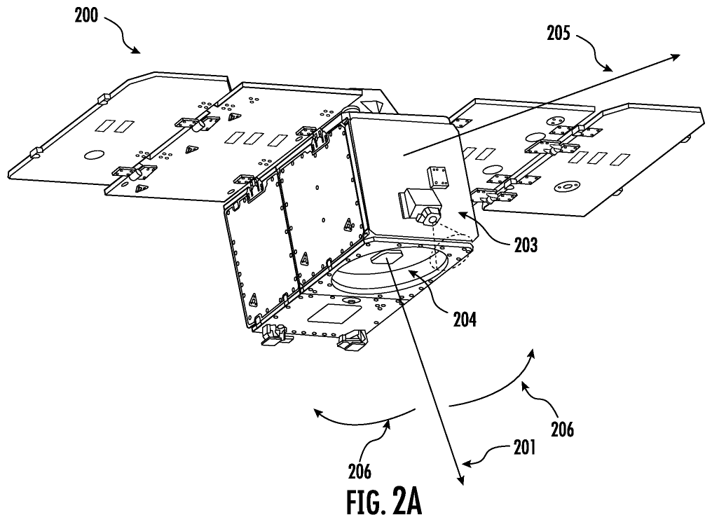

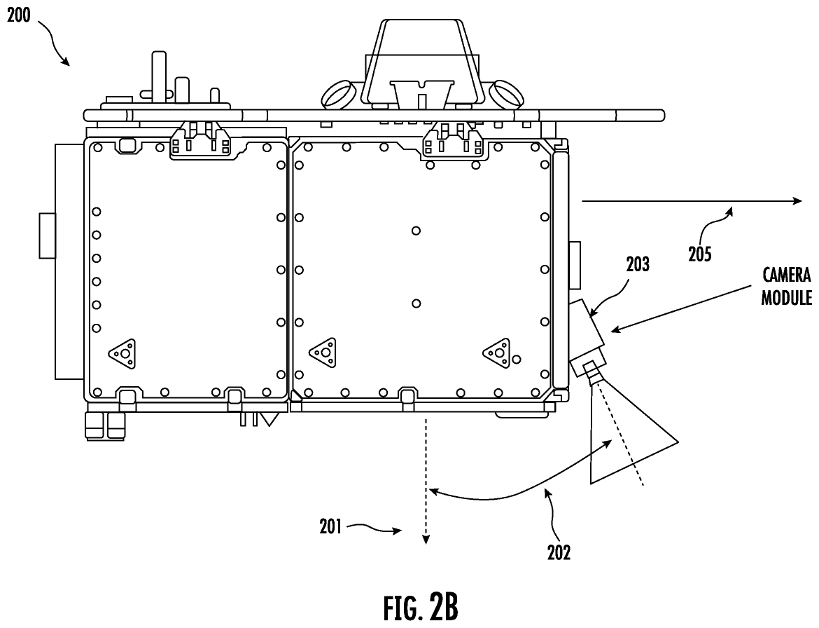

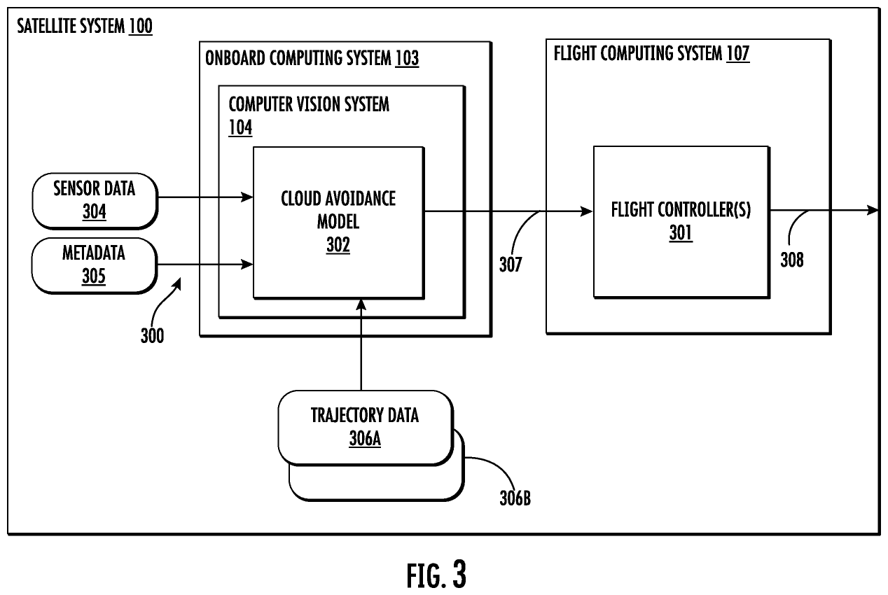

FIG. 2A-2B depicts an example satellite including a forward-looking sensor according to example aspects of the present disclosure. The example satellite 200 may include one or more physical components and instruments for performing various operations. The satellite 200 may be low earth orbit satellites, medium earth orbit satellites, polar orbit satellites, or any type of satellite capable of acquiring imagery. For instance, the satellite 200 may include a forward-looking sensor 203 affixed in a forward oriented position on a surface of the satellite 200. In some examples, the forward-looking sensor 203 may include a moveable sensor affixed to a surface of the satellite 200. In some examples, the forward-looking sensor 203 may be a camera sensor. The forward-looking sensor 203 may be VIS camera, LWIR camera, or any type of camera. In some examples, the forward-looking sensor 203 may be affixed to a front surface of the satellite 200. In other examples, the forward-looking sensor 203 may be affixed to any surface of the satellite 200 which allows for a look ahead angle 202. The look ahead angle 202 may be an angle relative to nadir or an optical axis 201 of a payload sensor of the satellite 200.

By way of example, the satellite 200 may orbit the Earth in an orbit path 205. The satellite 200 may include a payload sensor 204 which captures and transmits imagery of the Earth's surface. In some examples, the payload sensor 203 may be a camera sensor. The payload sensor 203 may be VIS camera, LWIR camera, or any type of camera. In some examples, the payload sensor 203 may be affixed to a downward facing surface of the satellite 200. For instance, the payload sensor 204 may acquire imagery directly below or within a field of view of the satellite 200. In some examples, the payload sensor 204 may acquire imagery which satisfies image acquisition commands. The satellite 200, in its neutral state, may have the payload sensor 204 pointed directly towards the Earth's surface, such that the payload sensor 204 captures images directly below the satellite 200 in its nadir field of view. The payload sensor 204 capturing imagery directly below the satellite is referred to as nadir. Conversely, the satellite 200 may be maneuverable such that the satellite 200 may have a slew trajectory 206 (i.e. tilt left or right relative to the orbit path 205) such that images may be captured which are not directly below the satellite-referred to as “off-nadir.” As such, by slewing the satellite 200, the optical axis 201 of the payload sensor 204 is moveable such that the field of regard of the payload sensor 204 exceeds the nadir field of view.

In some examples, the forward-looking sensor 203 may include a look ahead angle 202 of 25 degrees from the optical axis 201. The look ahead angle 202 may include a compound angle. For instance, the look ahead angle may include the slewing angle of the satellite 200 and the datum offset of the boresight of the forward-looking sensor 203. In some examples, the look ahead angle 202 may also include a portion (e.g., one half) of the look ahead sensor 203 field of view (FOV) such that the look ahead angle 202 aligns with the direct (LOS) line of sight of the forward-looking sensor 203. For instance, the forward-looking sensor 203 may include a FOV of 50 degrees. In some examples, the look ahead angle 202 may be a positive angle.

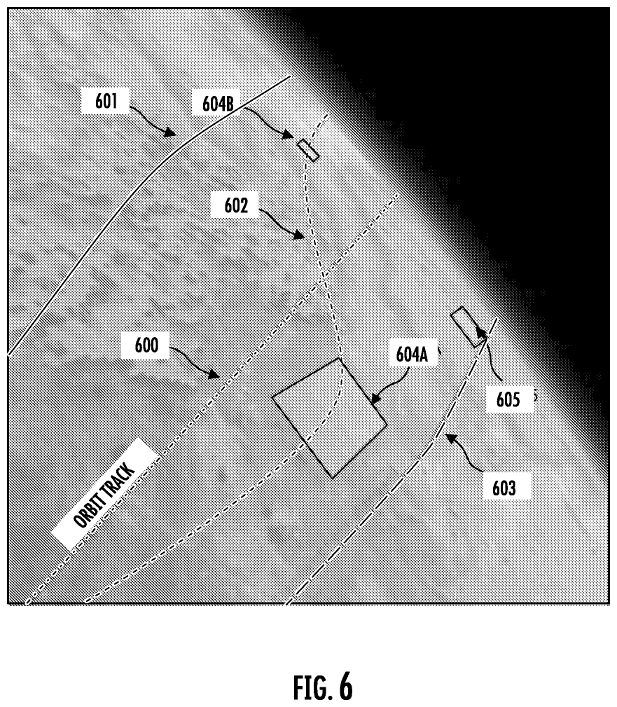

The satellite 200 may orbit the Earth on a slew trajectory using thrusters or reaction wheels (e.g., flight controllers). A slew trajectory 206 may allow the payload sensor 204 of the satellite 200 to have a moveable optical axis as the satellite 200 orbits the Earth. An example of a slew trajectory is further described with reference to FIG. 6. In some examples, the forward-looking sensor 203 may include a fish-eye field of view (e.g., wide field of view), such as 120 degrees or greater, such that the forward-looking sensor 203 can capture data that is not only within the future field of view of the payload sensor 204 when positioned on nadir, but also to capture imagery within the full future field of regard of the payload sensor when positioned off-nadir, thus encompassing the full range of geographic regions capable of being captured by a payload sensor of the satellite 200 within its potential (or capable) slew trajectory 206.

In some examples, the forward-looking sensor 203 may be configured to identify objects based on spectral bands. For instance, the forward-looking sensor 203 may include a SWIR and a LWIR sensor capable of detecting spectral bands. In some examples, the forward-looking 203 sensor may be configured to detect an object by detecting spectral bands associated with an object. For example, the forward-looking sensor 203 may identify an object as a cloud by detecting spectral bands (e.g., (1.36-1.38 μm, etc.) which correspond to a cloud.

In some examples, the forward-looking sensor 203 may acquire data indicative of the one or more geographic regions (e.g., imaging targets) ahead of the satellite 200 which have been scheduled for image acquisition. For instance, the forward-looking sensor 203 positioned at a 25 degree look ahead angle 202 may provide data indicative of more optimal imaging targets ahead of the satellite 200 based on the presence of clouds. For example, cloud coverage may obscure acquired images. The forward-looking sensor 203 positioned at a 25 degree look ahead angle 202 may provide timely data to one or more subsystems (e.g., onboard computing system 103, computer vision system 104, etc.) of the satellite 200 such that the satellite 200 may determine geographic regions ahead of the satellite 200 which are obscured by cloud cover and avoid the geographic regions which include cloud coverage. An example of a satellite utilizing sensor data captured by a forward-looking sensor 203 to avoid cloud coverage is further described with reference to FIG. 3.

FIG. 3 depicts a block diagram of an example data pipeline according to example aspects of the present disclosure. The following description of dataflow in data pipeline 300 is described with an example implementation in which the satellite system 100 utilizes a cloud avoidance model 302 to process sensor data 304, metadata 305, and trajectory data 306A, 306B to generate output 307 indicative of optimal imaging targets. The example implementation may also include flight controllers 301 which receive output 307 from the cloud avoid model 302 and generate output 308 to control a motion of the satellite system 100. Additionally, or alternatively, one or more portions of data pipeline 300 may be implemented offboard the satellite system 100.

The satellite system 100 may include a cloud avoidance model 302 that utilizes the sensor data 304, metadata 305, and trajectory data 306A, 306B to determine imaging targets which avoid cloud coverage. In some examples, the cloud avoidance model 302 may be a machine-learned-model. In some examples, the cloud avoidance model 302 may be an analytical model, empirical model, or any combination thereof capable of making a prediction.

In an embodiment, the cloud avoidance model 302 may be an unsupervised learning model configured to detect, identify, and segment objects depicted in an image frame. In some examples, the cloud avoidance model 302 may include one or more machine-learned models. For example, the cloud avoidance model 302 may include a machine-learned model trained to detect objects in a specific context (e.g., clouds over bodies of water, over land, etc.). In some examples, the cloud avoidance model 302 may include a machine-learned model trained to distinguish clouds from other objects such as snow, ice, or ocean foam by executing segmentation techniques.

The cloud avoidance model 302 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The cloud avoidance model 302 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames that have labels indicating cloud coverage and the segmentation of clouds (e.g., isolated clouds, storm/weather systems, etc.). In some examples, the training data may include simulated training data (e.g., training data obtained from simulated scenarios, inputs, configurations, previous satellite orbits, etc.).

Additionally, or alternatively, the model trainer(s) may perform unsupervised training techniques using unlabeled training data. By way of example, the model trainer(s) may train one or more components of a machine-learned model to execute cloud avoidance through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The cloud avoidance model 302 may obtain sensor data 304 from one or more sensors 101,102 of the satellite system 100. In some examples, the sensor data 304 may include image data. In some examples, the sensor data 304 may include video data. In some examples, the sensor data 304 may include image data captured by the forward-looking sensor 203. For instance, the cloud avoidance model 302 may obtain sensor data 304 including image data from the forward-looking sensor 203 depicting geographic regions ahead of the satellite system 100. For example, the satellite system 100 may be traveling along a current trajectory and the forward-looking sensor 203 may acquire sensor data 304 (e.g., image data, video data, etc.,) depicting geographic regions in the path of travel of the satellite 200 (e.g., satellite system 100).

In some examples, the sensor data 304 may include one or more image frames. For instance, the current trajectory data 306A of the satellite (e.g., satellite system 100) may be associated with scheduled image acquisitions. The scheduled image acquisitions may indicate requests for imagery of a specific geographic region (e.g., imaging targets). In some examples, the forward-looking sensor 203 may obtain sensor data 304 including one or more image frames depicting imaging targets scheduled for image acquisition ahead of the satellite system 100. By way of example, the satellite system 100 may be traveling along a current trajectory and the forward-looking sensor 203 may obtain sensor data 304 (e.g., one or more image frames) depicting imaging targets scheduled for image acquisition.

The cloud avoidance model 302 may access metadata 305 associated with one or more environmental conditions. Metadata 305 may include additional data which improves the accuracy of sensor data 304 or confidence level of the cloud avoidance model 302. For example, metadata 305 may include map data of historical cloud cover, monthly snow maps, land cover classifications, camera temperatures, sun angle, time of day, or altitude. Metadata may include any data which may be used to increase the accuracy of sensor data 304 or improve the confidence level of the cloud avoidance model 302. By way of example, sensor data 304 may include one or more image frames of a geographic region which depicts white cloud-like formations. Metadata 305 including a map of historical cloud cover may indicate a consistent pattern of cloud coverage over the geographic region. In some examples, the metadata 305 including the historical cloud cover may improve a confidence level determination of the cloud avoidance model 302 that the white cloud-like formation depicted in the sensor data 304 includes cloud coverage.

In some examples, the cloud avoidance model 302 may fuse the sensor data 304 and metadata 305. For instance, the cloud avoidance model 302 may be trained to detect the presence of clouds in an image frame. In some examples, the cloud avoidance model 302 may fuse the sensor data 304 and metadata 305 to identify additional features within the image frames which may increase the accuracy of the sensor data 304. In some examples, fusing the sensor data 304 and metadata 305 may compensate for environmental factors which may result in inaccurate identification of clouds. For instance, fusing the sensor data 304 and metadata 305 may help improve focal loss.

Metadata 305 may include any data which may adversely impact sensor data 304 or the sensors 101, 102. For instance, metadata 305 may include the camera (e.g., sensors 101, 102) temperature, sun angle, Earth surface angle, and slew angle may be fused with sensor data 304 to improve the accuracy of the sensor data 304. Sensor temperature metadata may include the temperature inside the satellite itself, the temperature of the geographic region detected by the sensor 101, 102, or any combination thereof. By way of example, sensor data 304 including an image frame of a geographic region may depict a bright cloud-like formation. In an embodiment, the cloud avoidance model 302 may fuse sensor data 304 with sensor temperature metadata indicating temperatures of the geographic region are below freezing. For instance, the sensor 102 may be a LWIR sensor capable of thermal imaging. The cloud avoidance model 302 may identify the bright cloud-like formation as snow or ice rather than a cloud based on the sensor temperature metadata. In another example, sensor temperature metadata may include a temperature of the payload sensor 204. For instance, the payload sensor may become hot causing adverse impacts to image quality.

In an embodiment, the cloud avoidance model 302 may fuse sensor data 304 with sun angle metadata, Earth surface metadata, and slew angle metadata. For instance, the flight computing system 107 may determine, based on its orbit position, the sun angle, Earth surface angle, and slew angle relative to the forward-looking sensor 203. In some examples, the angle at which the image frame was captured may result in varying brightness, exposure, shadows, density, contrast, saturation, etc. The cloud avoidance model 302 may more accurately identify the bright cloud-like formation as cloud cover rather than a reflection of light from land or other objects based on the sun angle metadata, Earth surface metadata, and slew angle metadata.

The cloud avoidance model 302 may access current trajectory data 306A indicating a current trajectory of the satellite (e.g., satellite system 100). In some examples, current trajectory data 306A may include the current speed, orbital position, or planned waypoints for the satellite. In some examples, the current trajectory data 306A may be transmitted over one or more connections from the flight computing system 107. In some examples, the current trajectory data 306A may be accessed from the storage system 105. For instance, the flight computing system 107 may actively store current trajectory data 306A in the storage system 105 where the onboard computing system 103 may access.

In some examples, the current trajectory data 306A may be associated with imaging targets (e.g., geographic regions). For instance, the current trajectory data 306A may indicate an orbit path or waypoint which passes over imaging targets scheduled for image acquisition. In some examples, the cloud avoidance model 302 may associate image frames included in sensor data 304 with geographic regions (e.g., imaging targets) which are scheduled for image acquisition. For instance, the cloud avoidance model 302 may fuse sensor data 304 and metadata 305 associated with imaging targets to determine whether the imaging targets scheduled for image acquisition include cloud coverage.

In some examples, the cloud avoidance model 302 may fuse the sensor data 304 and metadata 305 and process the image frames to determine cloud coverage associated with the imaging targets scheduled for image acquisition. For instance, as shown in FIG. 4 the cloud avoidance model 302 may receive an input image 401. Input image 401 may be sensor data 304 captured by a forward-looking sensor 203 of the satellite. In some examples, the input image 401 may include an image frame fused with metadata 305. In some examples, the cloud avoidance model 302 may perform cloud segmentation 402 techniques to segment the input image 401 based on the presence of clouds depicted in the image frame. In some examples, the cloud avoidance model 302 may perform cloud segmentation 402 techniques to segment the input image 401 based on imaging targets. For instance, the input image 401 may include a plurality of imaging targets and the input image 401 may be segmented based on the respective imaging targets. In some examples, the segmented image frames may include one or more objects (e.g., clouds). For instance, the segmented image frames may be analyzed to avoid cloud coverage.

Cloud segmentation 402 techniques may include analyzing the sensor data 304 (e.g., input image frame 401) fused with the metadata 305 and projecting a bounding shape on the image frame. A bounding shape may be any shape (e.g., polygon) that includes one or more imaging targets. Additionally, or alternatively, a bounding shape may include a shape that matches the outermost boundaries and contours of those boundaries for an imaging target. One of ordinary skill in the art will understand that other shapes may be used such as circles, squares, rectangles, etc. In some examples, the bounding shape may be generated on a per pixel level.

The cloud avoidance model 302 may perform cloud segmentation 402 to segment the input image 401 based on detecting one or more imaging targets and generate a box blur 403 to blur the input image 401 (e.g., image segments). The box blur 403 may include a blur filter encapsulating the image segment. In some examples, the box blur 403 may include a spatial domain linear filter. In some examples, the box blur 403 may reduce the clarity or sharpness of the input image 401. For instance, the cloud avoidance model 302 may employ a blur kernel (e.g., small matrix of numbers) to each pixel in the input image 401. The box blur 403 may include any image blurring technique such as Gaussian blur, defocus blur, motion blur, etc.

In some examples, the cloud avoidance model 302 may generate a box blur 403 to blur portions of the image segments. In some examples, the cloud avoidance model 302 may generate a box blur 403 to blur the entire image segment. For instance, the box blur 403 may blur a 5 km (kilometer) portion of the image segment. In some examples, the cloud avoidance model 302 may perform cloud segmentation 402 to segment the input image 401 into 5 km image segments. In some examples, the box blur 403 may be any dimensions such as 10 km, 20 km, etc. While examples here describe the blur box 403 as a post-processing operation, the cloud avoidance model 302 may also generate the blur box 403 during cloud segmentation 402 as a single operation.

The cloud avoidance model 302 may analyze the blurred image segments and determine one or more characteristics indicative of cloud coverage. For instance, the cloud avoidance model 302 may generate characteristics data (e.g., labels) that correspond to the characteristics of the bounding shape. Labels may include the classification of objects (e.g., land, water, etc.), the type of objects (e.g., clouds, snow, ocean foam, etc.), density, etc. In some examples, the characteristics data (e.g., labels) may indicate the presence of clouds in the blurred image segment. In some examples, the characteristics data may indicate the absence of clouds in the blurred image segment. In some examples, the box blur 403 may reduce the characteristics data needed to identify cloud coverage or the absence of clouds.

By way of example, the cloud avoidance model 302 may analyze the blurred image segments and label blurred objects within the blurred image frame based on fused metadata 305. For instance, the cloud avoidance model 302 may label a bounding shape which includes a blurred white cloud-like object as a cloud due to sensor temperature metadata indicating the temperature of the blurred white cloud-like object matches a temperature range typical of a cloud (e.g., cloud characteristic) in the geographic region. In some examples, the cloud avoidance model 302 may determine the blurred white cloud-like object is a cloud and generate a cloud label to indicate the presence of clouds.

In some examples, the cloud avoidance model 302 may determine an absence of clouds within the blurred image frame based on fused metadata 305. By way of example, the cloud avoidance model 302 may analyze a blurred image segment and label a bounding shape which includes a white cloud-like object as cloudless due to sun angle metadata and slew angle metadata which indicates the white cloud-like object appearance is a result of sunlight reflecting off a snow or ice surface. In some examples, cloud avoidance model 302 may determine the blurred image frame does not include cloud coverage and generate a cloudless label to indicate the absence of clouds.

In other examples, the cloud avoidance model 302 may determine a level of cloud cover depicted in a blurred image frame and generate a label indicating the level of cloud cover. For instance, the cloud avoidance model 302 may generate a cloud coverage level label. In some examples, the cloud coverage level label may be associated with a cloud label. In other examples, the cloud coverage level label may be nested within a cloud label. The cloud coverage level may be a percentage, ratio, or any measure of cloud coverage relative to the blurred image frame (e.g., geographic target). By way of example, the cloud avoidance model 302 may analyze a blurred image segment and detect the presence of clouds. In some examples, the cloud avoidance model 302 may determine a level of clouds within the blurred image frame. Determining a level of clouds may include determining the percentage of pixels associated with the detected cloud relative to the bounding shape within the blurred image segment. In some examples, the cloud avoidance model 302 may determine based on metadata 305 the level of cloud coverage within the blurred image frame. For instance, Earth surface angle metadata may indicate that the detected clouds are not dense enough to obscure an image acquisition. In some examples, the level of cloud coverage may be determined based on metadata 305 indicating the density of clouds depicted in the blurred image segment.

In some examples, the cloud avoidance model 302 may detect clouds within the blurred image segment and generate a cloud coverage level label to indicate the level of cloud coverage. The cloud coverage level label may include an integer value, percentage value, ratio, or any value which indicates a consistent measure of cloud coverage.

Returning to FIG. 3, the cloud avoidance model 302 may determine based on current trajectory data 306A and senor data 304 (e.g., image data) fused with metadata 305, one or more imaging targets and cloud coverage associated with the imaging target. For instance, the cloud avoidance model 302 may associate sensor data 304 (e.g., input image 401) with an imaging target based on current trajectory data 306A. The cloud avoidance model 302 may determine based on labeled blurred image segments the presence of clouds and the percentage of cloud coverage within the blurred image segment.

In some examples, the cloud avoidance model 302 may determine a comparison between the cloud coverage associated with an imaging target and a threshold level of cloud coverage. For instance, the current trajectory data 306A may include data associated with a cloud threshold or tolerance level for respective imaging targets. For example, the current trajectory data 306A, may indicate imaging targets scheduled for image acquisition.

In some examples, the imaging targets scheduled for image acquisition may indicate additional acquisition parameters. For instance, the imaging targets may indicate a cloud threshold or tolerance level to satisfy the acquisition request. By way of example, a cloud threshold or tolerance level of 30% may require that the acquired image contain no more than 30% cloud coverage to satisfy the image acquisition request. In some examples, the additional acquisition parameters may include a cost associated with the image acquisition. A cost may include commercial factors such as failure of previous attempts to acquire imagery, client value (e.g., priority of clients), or any other strategic prioritization rationale.

For instance, the cloud avoidance model 302 may determine a failure cost acquisition parameter associated with the image acquisition. The failure cost may include a generated integer or percentage value representing previous attempts associated with the image acquisition. In some examples, the failure cost may be any quantified representation of a previous failure associated with the image acquisition of a geographic region.

In some examples, the cloud avoidance model 302 may determine a client value acquisition parameter. The client value acquisition parameter may include a priority of clients (e.g., large clients, medium clients, small clients, etc.). For instance, large clients may include clients which generate large quantities of image acquisition requests. In some examples, large clients may be associated with a high priority acquisition parameter to indicate a higher priority for image acquisition requests associated with the large client. In other examples, small or medium clients may be associated with a lower priority acquisition parameters to indicate the lower priority of image acquisition requests associated with the small or medium clients.

In other examples, the image acquisition parameters may include other relationship considerations. For instance, the image acquisition parameter may include strategic reasons for prioritizing an image acquisition request. For example, the image acquisition requests may be associated with a new client. In some examples, new clients may be associated with a high priority image acquisition parameter to display an ability to satisfy future image acquisition requests for the new client. The image acquisition parameters may include any other strategic reason for prioritizing an image acquisition request.

In some examples, geography may also be considered. Geographic regions which are more difficult to acquire imagery satisfies a cloud threshold or tolerance level may be associated with a higher cost than other geographic regions due to the increased difficulty. In addition, a priority may be placed on certain geographic regions that rarely satisfy a cloud threshold or tolerance level, and thus may be prioritized in circumstances where the cloud threshold is met.

In other examples, the additional acquisition parameters may include a time parameter. The time parameter may indicate that the requested image must be acquired within a specified time period. By way of example, the time parameter may indicate that imagery be acquired within 72 hours from request.

The cloud threshold or tolerance level may include an integer value, percentage value, or any value which indicates a consistent measure of cloud coverage. In some examples, the cloud threshold or tolerance level may include an upper limit threshold, lower limit threshold or an exact threshold or tolerance level. In some examples, satisfying the threshold or tolerance level may include cloud coverage level above the cloud threshold, below the cloud threshold or exactly matching the cloud threshold.

The cloud avoidance model 302 may compare the cloud coverage level label of the blurred image segment to the cloud threshold or tolerance level for the requested imagery of the geographic region and determine imaging targets which satisfy the cloud threshold acquisition parameter. By way of example, the cloud avoidance model 302 may receive sensor data (e.g., input image 401), perform cloud segmentation 402 to segment the input image 401, generate a box blur 403 to blur the image segment, and label the blurred image segment. In some examples, the cloud avoidance model 302 may identify a first cloud and a second cloud covering a first and second geographic region (e.g., imaging targets) scheduled for image acquisition based on labelling blurred image segments. In some examples, the cloud avoidance model 302 may determine the cloud coverage level associated with the first and second imaging targets within the blurred image segments based on labelling the blurred image segment. The cloud avoidance model 302 determine based on current trajectory data 306A that the first imaging target includes a cloud threshold acquisition parameter of 10% and the second imaging target includes a cloud threshold acquisition parameter of 40%. The cloud avoidance model 302 may compare the cloud level labels for the respective imaging targets and determine the first imaging target should be avoided due to a cloud coverage label indicating 20% cloud coverage and a cloud coverage label indicating 25% cloud coverage for the second imaging target.

In some examples, the cloud avoidance model 302 may determine both first and second imaging targets satisfy their respective cloud threshold acquisition parameters and prioritize imaging targets based on other acquisition parameters. For instance, an imaging target may be associated with a time parameter that will be exceeded if the image is not acquired during the current orbit. In some examples, a cost acquisition parameter may influence priority of imaging targets which satisfy cloud threshold acquisition parameters. For instance, a first image acquisition may be valued higher than second image acquisition based on commercial factors (e.g., failure, client value, etc.) and may increase the priority of the imaging target and the cloud avoidance model 302 may determine the first imaging target should be acquired instead of the second imaging target.

The cloud avoidance model 302 may determine imaging targets which satisfy the cloud threshold acquisition parameters and transmit the imaging targets to the flight computing system 107 to generate an updated trajectory. For instance, the current trajectory data 306A may indicate that the current trajectory of the satellite (e.g., satellite system 100) will not pass over the imaging targets which satisfy the cloud threshold acquisition parameters (e.g., avoid cloud covered imaging targets). The cloud avoidance model 302 may generate output 307 indicative of the imaging targets that satisfy the cloud threshold acquisition parameters. In some examples, the cloud avoidance model 302 may transmit output 307 to the flight controller 301 of the flight computing system 107. In some examples the flight controllers 301 may be configured to receive the output 307. For instance, the output 307 may include one or more electrical signals.

By way of example, the flight controllers 107 of the flight computing system 107 may receive output 307 (e.g., electrical signals) over one or more connections from the cloud avoidance model 302 of the computer vision system 104. For instance the flight computing system may be configured to implement translated controls (e.g., electrical signals) from the computer vision system 103. In some examples, the flight computing system 107 may be configured to receive output 307 indicative of imaging targets and determine an updated trajectory. For instance, the current trajectory of the satellite system 100 may not include a way point or slew trajectory which passes over the imaging target indicated by the output 307. The flight computing system 107 may implement the output 307 by computing an updated trajectory and implementing operations to flight controllers 301. For instance, the flight controllers 301 may generate output 308 to control a motion of the satellite system 100. For example, the output 308 may include one or more command instructions to control a motion of the satellite based on the updated trajectory.

In some examples, the flight computing system 107 may determine the output 307 received from the cloud avoidance model 302 cannot be executed. For instance, the flight computing system 107 may determine, based on the current position, orbital speed, slew angle, etc. that navigating to an imaging target indicated by the output 307 results in a low probability of reaching the imaging target. For instance, the satellite system 100 may orbit the Earth at thousands of miles per hour and updating the trajectory may require sufficient time to maneuver without missing the imaging target. In some examples, the flight computing system 107 may determine the output 307 indicative of an updated trajectory is not possible or has a low probability of passing over the imaging target and generate updated trajectory data 306B accessible by the cloud avoidance model 302 to recompute the output 307 (e.g., imaging targets). Passing over the imaging target may include aligning the payload sensor 204 with the imaging target. In some examples, passing over the imaging target may include aligning the payload sensor 204 with a field of view (e.g., off-nadir) of the imaging target. An example, of the cloud avoidance model 302 recomputing output 307 is further 27 described with reference to FIG. 5

In some examples, the flight computing system 107 may determine the output 307 indicative of an updated trajectory is not possible or has a low probability of acquiring off-nadir imagery and generate updated trajectory data 306B accessible by the cloud avoidance model 302 to recompute the output 307. For instance, the payload sensor 204 may acquire imagery which is not directly below the satellite 200 as the satellite 200 slews. In some examples, the imaging target may be outside of the field (e.g., off-nadir) of view of payload sensor 204. For instance, sensor data 304 captured by the forward-looking sensor 203 may include the geographic regions in the field of view of the payload sensor 204 based on the current position, orbital speed, slew angle, etc. of the satellite 200 (e.g., satellite system 100). As the satellite 200 orbits the earth the position, orbital speed, slew angle, etc. may change such that the output 307 indicative of an updated trajectory is not possible or has a low probability of acquiring off-nadir imagery.

FIG. 5 depicts a flow diagram of an example method 500 for recomputing targets according to example aspects of the present disclosure. One or more portion(s) of the method 500 may be implemented by a computing system that includes one or more computing devices such as, for example, the computing systems described with reference to the other figures (e.g., a satellite system 100, onboard computing system 103, computer vision system 104, flight computing system 107, etc.). Each respective portion of the method 500 may be performed by any (or any combination) of one or more computing devices. Moreover, one or more portion(s) of the method 500 may be implemented as an algorithm on the hardware components of the device(s) described herein.

At (505), the sensors 101, 102 of the satellite system 100 may capture sensor data 304 (e.g., input image 401). In some examples, the sensor data 304 may be captured by the forward-looking sensor 203 of the satellite. In some examples, the sensor data 304 may include a forward-looking image (FLI) of the geographic regions ahead of the satellite. The FLI may include sensor data 304 depicting geographic regions ahead of the satellite 200.

At (510), the cloud avoidance model 302 may perform cloud segmentation 402 to segment the input image 401. For instance, the cloud avoidance model 302 may segment the input image 401 based on objects (e.g., cloud-like objects) detected in the input image, imaging targets, etc. In some examples, the cloud avoidance model 302 may blur the image segments and label the blurred image segments to identify object characteristics (e.g., cloud characteristics). For instance, the cloud avoidance model 302 may label the blurred image segments as clouds and generate labels indicative of the level of cloud coverage within the blurred image segment.

The cloud avoidance model 302 may determine, based on comparing the level of cloud coverage for the respective image frame (e.g., imaging target) to a cloud threshold acquisition parameter, imaging targets which satisfy the cloud threshold acquisition parameter. In some examples, the cloud avoidance model 302 may output 307 data indicating the imaging targets which satisfy the cloud threshold acquisition parameter and transmit the output to the flight computing system 107.

At (515-520), the flight computing system 107 may receive the output 307 from the cloud avoidance model 302 and compute a trajectory of the satellite 200 which includes the imaging targets defined within the output 307. In some examples, the flight computing system 107 may implement the output 307 operations to flight controllers 301. For instance, the flight controllers 301 may determine an updated trajectory and generate output 308 to control a motion of the satellite system 100. In some examples, the output 308 may include one or more command instructions to control a motion of the satellite 200 based on the updated trajectory. In some examples, the command instructions may cause the satellite 200 to travel along the updated trajectory.

At (525), the flight controllers 301 may be unable to adjust the trajectory of the satellite 200 to travel along the updated trajectory. The trajectory may include the current orientation and direction of the satellite. In some examples, the slew trajectory 206 may be a subset of the trajectory of the satellite. For instance, the slew trajectory 206 may include a slew angle or position relative to the overall trajectory (e.g., orientation, direction, position, etc.) of the satellite as it travels along an orbit path 205. For instance, the probability of the satellite 200 passing over the imaging target indicated by the cloud avoidance model 302 may be low based on the current position of the satellite 200 orientation, orbital speed, slew position or angle, etc. In some examples, the flight controllers 301 may not have sufficient power or resources to execute the computed trajectory. For instance, thruster or reaction wheels may require additional power to align the satellites with the computed trajectory quickly enough to pass over determined imaging targets.

In some examples, the probability of imminently passing over may be calculated by the flight computing system 107. For instance, the flight computing system 107 may include different subsystems, software, and hardware for performing various flight control operations. In some examples, the probability of an imminently passing over may be calculated using orbital speed equations, acceleration equations, orbital period equations, etc. In some examples, the resulting calculations may produce probability of the satellite 200 passing over the imaging target. In some examples, a low probability of imminently passing over may be determined if the calculated probability is below 50%. In some examples, a low probability of imminently passing over may be determined if the calculated probability is below 70%. In some examples, any probability percentage may be considered a low probability. In other examples, a low probability of imminently passing over may be determined based on additional factors such as image acquisition parameters, priority of scheduled image acquisitions, or availability of other satellites to acquire the requested imagery.

By way of example, the flight computing system 107 may determine a low probability of imminently passing over by calculating a 60% chance of passing over the imaging target. In some examples, the flight computing system may transmit via the communications system 106 data indicating the low probability of imminent overpass to a ground station and a second satellite may be assigned to acquire the imagery which includes an 80% probability of imminent overpass.

At (530), the flight computing system 107 may determine a low probability of passing over the determined imaging targets and transmit data to the onboard computing system 103 to execute steps (510-520). In some examples, the flight computing system 107 may transmit data to the onboard computing system 103 to cause the forward-looking sensor 203 to capture additional sensor data 304. For instance, the satellite may be orbiting at thousands of miles per hour and an updated input image 401 may be needed to recompute the trajectory of the satellite.

At (535), the flight computing system 107 may determine a high probability of imminent overpass and generate one or more command instructions to control a motion of the satellite based on the updated trajectory. A high probability may include 70% or greater, 60% or greater, or any reasonable percentage. The satellite may pass over the determined imaging target and utilize one or more sensors 101, 102 to acquire imagery of the respective geographic region. In some examples, the satellite system 100 may downlink the acquired imagery to a ground station at a point during orbit where the communication system 106 may transmit the acquired imagery.

FIG. 6 depicts an example satellite maneuvering plan according to example aspects of the present disclosure. The example maneuvering plan includes an orbit track 600 which illustrates the location of a satellite (e.g., satellite system 100, satellite 200, etc.) as it orbits the Earth. In some examples, the orbit track 600 may indicate a complete path around the earth. In some examples, the orbit track 600 may prevent satellites from colliding. For instance, the orbit track 600 may indicate a unique path of travel for the satellite which allows for the coordination or orchestrion of other satellites orbiting the Earth. For example, a plurality of satellites in a constellation may simultaneously orbit the Earth on various orbit tracks 600 which do not intersect or interfere with other satellite orbits. In other examples, the orbit track 600 may be shared by multiple satellites such that the satellites are in orbit positions spaced on the same on the orbit track 600 to avoid collisions.

Satellites having maneuvering capabilities may be capable of “slewing” as the satellite progresses along the orbit track 600. For example, while the satellite may maintain its position on the orbit track 600, it may slew left or right, relative to its direction of travel, such that geographic areas of Earth may be captured (i.e., by the payload sensor 204) which are not directly below the position of the satellite on the orbit track 600. While slewing allows a satellite to capture imagery which is not directly below its orbit track 600, greater amounts of skewing alter the perspective of the captured imagery and may be undesirable beyond a certain slew angle 206. Therefore, a predefined upper edge 601 and lower edge 603 may be established which represent the upper and lower boundaries within which potential imaging targets are located.

For example, a satellite may slew between an upper edge 601 and a lower edge 603, to capture images various imaging targets 604 between the upper edge 601 and the lower edge 603, creating an optimized slew track 602 as it orbits the Earth. For instance, the optimized slew track 602 may indicate an updated trajectory (e.g., output 308) based on output 307 generated by the cloud avoidance model 302 of the satellite system 100. In some examples, the optimized slew track 602 may include an optimized slew trajectory that passes over imaging targets 604A, 604B which do not include cloud coverage (e.g., avoiding clouds) or cloud coverage below the cloud coverage acquisition parameter. In some examples, the optimized slew track 602 may include the satellite's orientation (e.g., angle, position, etc.) or movement in reference to its orbit track 600. As depicted in FIG. 6, a satellite may navigate along the optimized slew track 602 above or below the orbit track.

In some examples, the optimized slew track 602 may be determined in consideration of cloud coverage at various imaging targets 604. For instance, the optimized slew track 602 may avoid imaging target 604C based on its cloud coverage levels. For instance, imaging target 604C may be assigned to the satellite 200 traveling along the orbit track 600 as a result of the proximity of the imaging target 604C relative to the orbit track 600. In some examples, imaging target 604C may be assigned to the satellite traveling along the orbit track 600 as a result of the imaging target 604C being positioned within a field of view of the forward-looking sensors 203. For instance, the forward-looking sensor 203 may include a fish-eye field of view which encompasses the field of view of the payload sensor 204.

In some examples, the satellite may detect cloud coverage at the imaging target 604C which exceed the cloud coverage acquisition parameter, and avoid imaging target 604C based on detecting the presence of clouds For instance, imaging target 604C may be associated with a 30% cloud coverage acquisition parameter and determine imaging target 604C is 70% obstructed cloud coverage. Thus, the satellite may avoid imaging target 604C based the cloud coverage above the cloud coverage acquisition parameter and instead update the optimized slew track 602 to acquire imagery of imaging target 604B instead.

For further illustration, after completing image acquisition of imagery target 604A, the current trajectory data (e.g., current trajectory data 306A) may indicate imagery target 604C as the next target scheduled for image acquisition. The cloud avoidance model (e.g. cloud avoidance model 302) may determine that imagery target 306C does not meet satisfy the cloud coverage acquisition parameter, and thus the optimized slew track 602 may be updated by the flight computing system (e.g. flight computing system 107) to slew the satellite to be positioned to capture imagery target 604B instead.

In some examples, the satellite may include a field of regard and may travel along the optimized slew track 602 within the field of regard. A field of regard may include the total area that a sensing system (e.g., forward-looking sensor 203) can perceive. In some examples, the field of regard may be based on the total area visible to the forward-looking sensor 203. In some examples, the field of regard may be greater than the FOV of the forward-looking sensor 203. For instance, the field of regard may be equal to or greater than the fish-eye field of view of the forward looking sensor 203. In some examples, the field of regard may include off-nadir geographic regions visible by the payload sensor 204 in addition to the total area visible by the forward-looking sensor 203. For instance, the field of regard may include an upper edge 601 and a lower edge 603. In some examples, the forward-looking sensor 203 may capture sensor data 304 depicting geographic regions within the upper edge 601 and lower edge 603 of the field of regard. In some examples, the optimized slew track 602 may be positioned within the upper edge 601 and lower edge 603 of the field of regard due to the sensor data 304 captured by the forward-looking sensor 203 including input images 401 which include geographic regions within the upper edge 601 and lower edge 603. In some examples, the forward-looking sensor 203 may be moveable and cause the upper edge 601 and lower edge 603 of the field of regard to change as the forward-looking sensor 203 moves. As the satellite slews within the upper edge 601 and the lower edge, the payload sensor 204 may be positioned to include an off-nadir field of view greater than the fish-eye field of view of the forward-looking sensor 203.

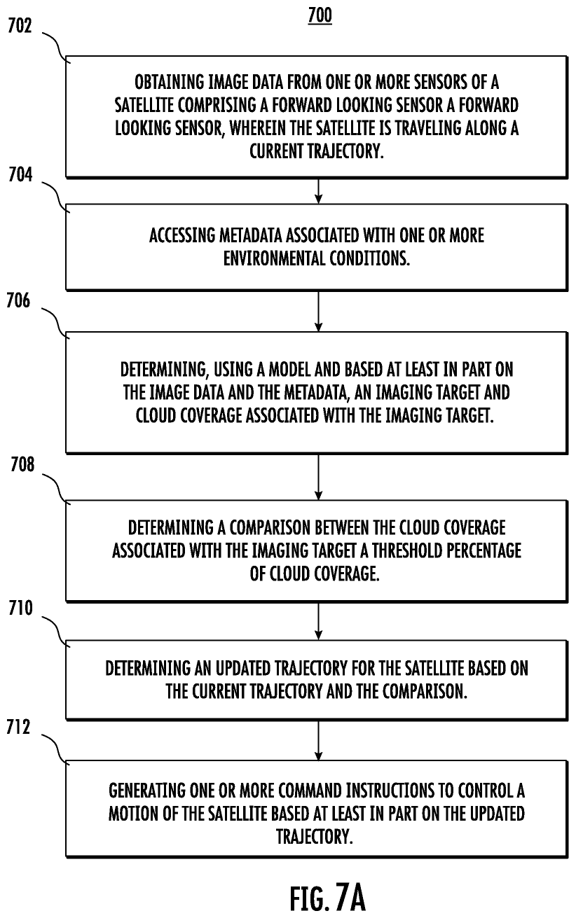

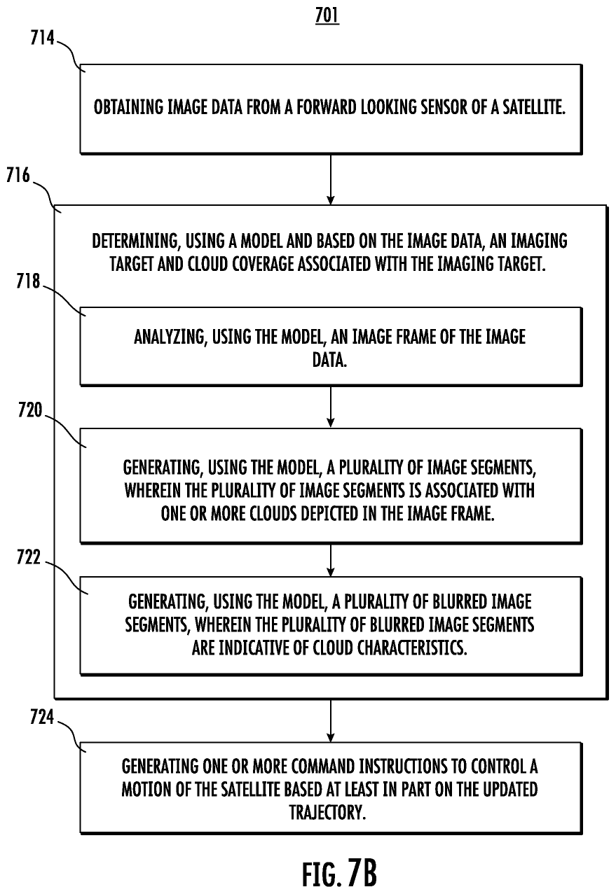

FIG. 7A depicts a flow diagram of an example method 700 according to example embodiments of the present disclosure. One or more portion(s) of the method 700 may be implemented by a computing system that includes one or more computing devices such as, for example, the computing systems described with reference to FIGS. 1-6. Each respective portion of the method 700 may be performed by any (or any combination) of one or more computing devices. Moreover, one or more portion(s) of the method 700 may be implemented as an algorithm on the hardware components of the device(s) described herein, for example, to control satellites to avoid clouds. FIG. 7 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, and/or modified in various ways without deviating from the scope of the present disclosure. FIG. 7 is described with reference to elements/terms described with respect to other systems and figures for example illustrated purposes and is not meant to be limiting. One or more portions of method 700 may be performed additionally, or alternatively, by other systems.

At (702), the method 700 may include obtaining image data from one or more sensors of a satellite comprising a forward-looking sensor, wherein the satellite is traveling along a current trajectory. As described herein, the sensor data 304 may be captured by a forward-looking sensor 203 of the satellite 200. The forward-looking sensor 203 may be affixed in a forward oriented position on a surface of the satellite 200. In some examples, the forward-looking sensor 203 may be a camera sensor. The forward-looking sensor 203 may be VIS camera, LWIR camera, or any type of camera. In some examples, the sensor data 304 including the image data (e.g., input image 401) may be used as input into a machine-learned cloud avoidance model 302.

At (704), the method 700 may include accessing metadata associated with one or more environmental conditions. For instance, metadata 305 may include additional data which improves the accuracy of sensor data 304 or confidence level of the cloud avoidance model 302. For example, metadata 305 may include environmental conditions such as map data of historical cloud cover, monthly snow maps, land cover classifications, camera temperatures, sun angle, time of day, or altitude. Metadata 305 may include any data which may be used to increase the accuracy of sensor data 304 or improve the confidence level of the cloud avoidance model 302.

By way of example, metadata 305 including a map of historical cloud cover may indicate a consistent pattern of cloud coverage over a geographic region. In some examples, the metadata 305 including the historical cloud cover may improve a confidence level determination of the cloud avoidance model 302 that a white cloud-like formation depicted in the sensor data 304 includes cloud coverage. In some examples, the metadata 305 may be used as input into the cloud avoidance model 302.

At (706), the method 700 may include determining, using a model and based at least in part on the image data and the metadata, an imaging target and cloud coverage associated with the imaging target. For instance, the forward-looking sensor 203 of the satellite may capture sensor data 304 including an input image 401 indicative of geographic regions within a field of regard of the forward-looking sensor 203. In some examples, sensor data 304 including an input image 401 may be fused with the metadata 305 to compensate for any environmental factors and increase the accuracy of the input image 401. In some examples, a cloud avoidance model 302 may perform cloud segmentation 402 techniques to segment the input image 401 fused with the metadata 305 based on objects (e.g., clouds) or imaging targets depicted in the input image 401 fused with the metadata 305. In some examples, the cloud avoidance model 302 may generate a box blur to blur the image segment.

The cloud avoidance model 302 may determine the blurred image segment depicts cloud coverage and may generate labels indicative of cloud characteristics. For instance, the cloud avoidance model 302 may generate a label indicating the object depicted in the blurred image segment is a cloud and generate a label indicating the level of cloud coverage.

By way of example, the cloud avoidance model 302 may analyze the blurred image segments and generate a bounding shape to encapsulate cloud-like objects depicted in the image frame. In some examples, the cloud avoidance model 302 may identify a cloud depicted in the bounding shape and generate a cloud label. In some examples, the cloud avoidance model 302 may determine a level of cloud cover depicted in a blurred image frame and generate a label indicating the level of cloud cover.

In some examples, the cloud coverage level label may be associated with a cloud label. In other examples, the cloud coverage level label may be nested within a cloud label. Determining a level of clouds may include determining the percentage of pixels associated with the detected cloud relative to the bounding shape within the blurred image segment. In some examples, the cloud avoidance model 302 may determine based on metadata 305 the level of cloud coverage within the blurred image frame. For instance, Earth surface angle metadata may indicate that the detected clouds are not dense enough to obscure an image acquisition. In some examples, the level of cloud coverage may be determined based on metadata indicating the density of clouds depicted in the blurred image segment.

In some examples, the cloud avoidance model 302 may detect clouds within the blurred image segment and generate a cloud coverage level label to indicate the level of cloud coverage. The cloud coverage level label may include an integer value, percentage value, or any value which indicates a consistent measure of cloud coverage.

At (708), the method 700 may include determining a comparison between the cloud coverage associated with the imaging target and a threshold level of cloud coverage. For instance, the current trajectory data 306A may include data associated with a cloud threshold or tolerance level for respective imaging targets. For example, the current trajectory data 306A, may indicate imaging targets scheduled for image acquisition. In some examples, the imaging targets scheduled for image acquisition may indicate additional acquisition parameters. For instance, the imaging targets may indicate a cloud threshold or tolerance level to satisfy the acquisition request. The cloud threshold or tolerance level may include an integer value, percentage value, or any value which indicates a consistent measure of cloud coverage. In some examples, the cloud threshold or tolerance level may include an upper limit threshold, lower limit threshold or an exact threshold or tolerance level. In some examples, satisfying the threshold or tolerance level may include a cloud coverage level above the cloud threshold, below the cloud threshold or exactly matching the cloud threshold.

The cloud avoidance model 302 may compare the cloud coverage level label of the blurred image segment to the cloud threshold or tolerance level for the requested imagery of the geographic region and determine imaging targets which satisfy the cloud threshold acquisition parameter.

At (710), the method 700 may include determining an updated trajectory for the satellite based on the current trajectory and the comparison. For instance, the cloud avoidance model 302 may determine one or more imaging targets which satisfy the cloud threshold acquisition parameter based on the comparison between the cloud coverage level label of the blurred image segment to the cloud threshold or tolerance level for the requested imagery of the geographic region.

In some examples, the cloud avoidance model 302 may output 307 indicative of an updated trajectory which includes the imaging targets that satisfy the cloud threshold acquisition parameters. In some examples, the cloud avoidance model 302 may transmit output 307 to a flight controller 301 of the flight computing system 107. In some examples the flight controllers 301 may be configured to receive the output 307 and generate an updated trajectory based on the output 307.

At (712), the method 700 may include generating one or more command instructions to control a motion of the satellite based at least in part on the updated trajectory. For instance, the flight controllers 107 of the flight computing system 107 may determine the current trajectory does not include a slew trajectory which passes over the imaging targets or a possible off-nadir position of the payload sensor 204 indicated in the output 307. For instance, the payload sensor 204 may acquire imagery off-nadir (e.g., not directly below the satellite 200). In some examples, the off-nadir imagery may be captured by the satellite as it travels along the slew trajectory. In some examples, the flight computing system 107 may determine that an off-nadir image is not possible based on the current trajectory (e.g., position, orientation, etc.) of the satellite. In other examples, the flight computing system 107 may determine an off-nadir image would be distorted based on the current trajectory of the satellite. The flight computing system 107 may generate an updated trajectory which includes waypoints, etc. that pass over the imaging targets indicated in the output 307. For instance, the flight controllers 301 may generate output 308 to control a motion of the satellite system. In some examples the output 308 may include one or more command instructions to control a motion of the satellite based on the updated trajectory.

While FIG. 7A describes the determination of imaging targets for a single satellite system 100, the present disclosure is not limited to such an embodiment. The imaging targets may be communicated to other satellites in a constellation. For instance, the model may determine an imaging target that the satellite will not pass over and communicate the imaging target to another satellite which has a higher probability of passing over the imaging target. As such the present disclosure may be implemented by a constellation of imaging satellites.

By way of example, the cloud avoidance model 302 may determine based on the current schedule of pending image acquisitions and associated image acquisition parameters that acquiring the requested imagery for an imaging target is unlikely. For instance, the cloud avoidance model 302 may prioritize imaging targets based on commercial factors such that a threshold number of orbits will be required to acquire the requested imagery for the imaging target. The threshold number of orbits may include 2 orbits, 3 orbits, or any number of orbits. In some examples, the threshold number of orbits may be based on a time acquisition parameter. For instance, the time acquisition parameter may indicate that imagery for the imaging target must be acquired prior to a priority status associated with the imaging target. The satellite system 100 may communicate via the communication system 106 data indicating the image acquisition command cannot be satisfied by the respective satellite 200. In some examples, the satellite system 100 may communicate with a ground station. In other examples, the satellite system 100 may communicate with other satellites 200 in a constellation. For instance, a second satellite 200 may include an optimal orbit track 600, or trajectory (e.g., slew trajectory) which is capable of acquiring the requested imagery. In some examples, multiple satellites 200 may be spaced along the same or similar orbit track 600.

In some examples, the satellite 200 may be occupied with another task and is unable to satisfy the image acquisition command. For instance, the satellite 200 may be tasked with downlinking acquired imagery and is unable to generate an updated trajectory to downlink acquired imagery and satisfy the image acquisition command. In some examples, the satellite 200 may communicate with a ground station (e.g., during a downlink) or directly with other satellites 200 in the constellation to indicate the inability to satisfy the image acquisition command.

In some examples, the satellites in the constellation may include different payload capabilities. For instance, the satellite 200 may include a payload sensor 204 with a deep focus lens. In some examples, the satellite 200 may require a payload sensor with a shallow focus lens due to a trajectory which causes an off-nadir imaging position, less-closely oriented position relative to the imaging target, etc. In some examples, another satellite within the satellite constellation (or a different satellite constellation) may include a shallow focus lens necessary for satisfying the image acquisition command. Similarly, other satellites may include different sensor characteristics which may be preferred or which may be more capable for collection of data from a given geographic area. For example, the satellite 200 may include a payload sensor 204 which is an optical or multi-spectral, but which does not possess other payload sensors. Another satellite which is under the control of the same satellite operator may include a different payload sensor, for example including, hyperspectral, infrared, NIR (near-infrared), SWIR (short-wave infrared), MWIR (mid-wave infrared), radar (including synthetic-aperture radar (SAR)), etc. Similarly, other satellites may include different resolution and/or capture size (e.g., swath width) characteristics. In some examples, the satellite 200 may communicate with another satellite which includes the capabilities required or desired to acquire the requested imagery.

A second satellite in a satellite constellation may receive the image acquisition command from a first satellite and generate an updated trajectory to pass over the associated imaging target. In some examples, the second satellite may align a payload sensor with the imaging target and acquire the rested imagery. In some examples, the second satellite may pass over a geographic region near the imaging target and capture nadir or off-nadir imagery of the imaging target.

In some examples, satellite 200 may have low spatial resolution. Given this, satellite 200 may be of relatively low cost and small size. The satellite 200 may send an image acquisition command to a second satellite which has higher resolution. In this way, the satellite 200 can act as a scout for the higher resolution satellite, such that the more valuable payload sensor is used more efficiently based on received image acquisition commands from the (first) lower cost, satellite 200.

In some examples, satellites having different payload sensor 204 capabilities are impacted differently by cloud cover. For example, the satellite 200 may have a payload sensor 204 which is impacted by clouds (e.g., optical sensor), and thus a given imaging target may not be suitable for imagery capture given cloud coverage, as determined by the cloud avoidance model 302. However, a second satellite may include a different payload sensor which is not impacted, or is less impacted, by cloud cover (e.g. synthetic-aperture radar (SAR)). In such circumstances, the satellite 200 may send an acquisition command to the second satellite to acquire an data (using SAR, for example) from the cloud-obstructed area. That may, for example, provide an alternative to the satellite operator to collect data of the imagery target, as an alternative to optical data given the cloud coverage, and could provide an alternative imagery collection path which could utilize analytic techniques to synthetically process optical imagery to remove cloud cover.

FIG. 7B depicts a flow diagram of an example method 701 according to example embodiments of the present disclosure. One or more portion(s) of the method 701 may be implemented by a computing system that includes one or more computing devices such as, for example, the computing systems described with reference to FIGS. 1-6. Each respective portion of the method 701 may be performed by any (or any combination) of one or more computing devices. Moreover, one or more portion(s) of the method 701 may be implemented as an algorithm on the hardware components of the device(s) described herein, for example, to control satellites to avoid clouds. FIG. 7B depicts elements performed in a particular order for purposes of illustration and discussion. Those of ordinary skill in the art, using the disclosures provided herein, will understand that the elements of any of the methods discussed herein may be adapted, rearranged, expanded, omitted, combined, and/or modified in various ways without deviating from the scope of the present disclosure. FIG. 7B is described with reference to elements/terms described with respect to other systems and figures, for example illustrated purposes and is not meant to be limiting. One or more portions of method 701 may be performed additionally, or alternatively, by other systems.

At (714), the method 701 may include obtaining image data from a forward looking sensor of a satellite. For instance, the forward-looking sensor 203 may include a look ahead angle 202 of 25 degrees from nadir. The look ahead angle 202 may include a compound angle. For instance, the look ahead angle may include the slewing angle of the satellite 200 and the datum offset of the boresight of the forward-looking sensor 203. In some examples, the look ahead angle 202 may also include a portion (e.g., one half) of the look ahead sensor 203 field of view (FOV) such that the look ahead angle 202 aligns with the direct (LOS) line of sight of the forward-looking sensor 203. For instance, the forward-looking sensor 203 may include a FOV of 50 degrees. In some examples, the look ahead angle 202 may be a positive angle. The forward-looking sensor 203 may capture image data (e.g., sensor data 304) including images of geographic regions ahead of the satellite.

At (716), the method 701 may include determining, using a model and based on the image data, an imaging target and cloud coverage associated with the imaging target. At (716), the method 701 may include (718)-(722). For instance, the cloud avoidance model 302 may obtain an input image 401. Input image 401 may be sensor data 304 (e.g., image data) captured by the forward-looking sensor 203 of the satellite 200. In some examples, the input image 401 may include an image frame fused with metadata 305. The input image 401 may include a plurality of imaging targets and the input image 401 may include respective imaging targets within the input image 401.

At (718), the method may include analyzing, using the model an image frame of the image data. For instance, the cloud avoidance model 302 may analyze the sensor data 304 (e.g., input image frame 401) fused with the metadata 305 and project a bounding shape on the image frame. In some examples, the bounding shape may encapsulate geographic regions associated with imaging targets depicted in the image frame. In other examples, the bounding shape may encapsulate objects (e.g., clouds, landmasses, water, ice, etc.) depicted in the image frame. In some examples, the cloud avoidance model 302 may process the image frames to determine cloud coverage associated with the imaging targets scheduled for image acquisition.

At (720), the method 701 may include generating, using the model, a plurality of image segments, wherein the plurality of image segments is associated with one or more clouds depicted in the image frame. The cloud avoidance model 302 may perform cloud segmentation 402 to segment the input image 401 based on detecting one or more imaging targets. In some examples, the cloud avoidance model 302 may perform cloud segmentation 402 to segment the input image 401 based on detecting one or more objects.

At (722) the method 701 may include generating, using the model, a plurality of blurred image segments, wherein the plurality of blurred image segments are indicative of cloud characteristics. For instance, the cloud avoidance model 302 may perform cloud segmentation 402 to segment the input image 401 based on detecting one or more imaging targets and generate a box blur 403 to blur the input image 401 (e.g., image segments). The box blur 403 may include a blur filter encapsulating the image segment. In some examples, the box blur 403 may include a spatial domain linear filter. In some examples, the box blur 403 may reduce the clarity or sharpness of the input image 401. For instance, the cloud avoidance model 302 may employ a blur kernel (e.g., small matrix of numbers) to each pixel in the input image 401. The box blur 403 may include any image blurring technique such as Gaussian blur, defocus blur, motion blur, etc.

The cloud avoidance model 302 may analyze the blurred image segments and determine one or more characteristics indicative of cloud coverage. For instance, the cloud avoidance model 302 may generate characteristics data (e.g., labels) that correspond to the characteristics of the bounding shape. Labels may include the classification of objects (e.g., land, water, etc.), the type of objects (e.g., clouds, snow, ocean foam, etc.), density, etc. In some examples, the characteristics data (e.g., labels) may indicate the presence of clouds in the blurred image segment. In some examples, the characteristics data may indicate the absence of clouds in the blurred image segment. In some examples, the box blur 403 may reduce the characteristics data needed to identify cloud coverage or the absence of clouds.

At (724), the method 701 may include determining, using the model, the cloud coverage associated with respective blurred image segments of the plurality of blurred image segments. For instance, the cloud avoidance model 302 may generate a cloud coverage level label. In some examples, the cloud coverage level label may be associated with a cloud label. In other examples, the cloud coverage level label may be nested within a cloud label. The cloud coverage level may be a percentage, ratio, or any measure of cloud coverage relative to the blurred image frame (e.g., geographic target). By way of example, the cloud avoidance model 302 may analyze a blurred image segment and detect the presence of clouds. In some examples, the cloud avoidance model 302 may determine a level of clouds within the blurred image frame. Determining a level of clouds may include determining the percentage of pixels associated with the detected cloud relative to the bounding shape within the blurred image segment. In some examples, the cloud avoidance model 302 may determine based on metadata 305 the level of cloud coverage within the blurred image frame. For instance, Earth surface angle metadata may indicate that the detected clouds are not dense enough to obscure an image acquisition. In some examples, the level of cloud coverage may be determined based on metadata 305 indicating the density of clouds depicted in the blurred image segment.

In some examples, the cloud avoidance model 302 may detect clouds within the blurred image segment and generate a cloud coverage level label to indicate the level of cloud coverage. The cloud coverage level label may include an integer value, percentage value, ratio, or any value which indicates a consistent measure of cloud coverage.

While FIG. 7B describes the determination of cloud coverage depicted in a single image frame, the present disclosure is not limited to such an embodiment. The determination of cloud coverage may be determined across a plurality of image frames. For instance, the model may determine cloud coverage by analyzing, segmenting, and blurring a plurality of image frames captured over a period of time. As such the present disclosure may be implanted over a period of time as the satellite travels along its orbit.

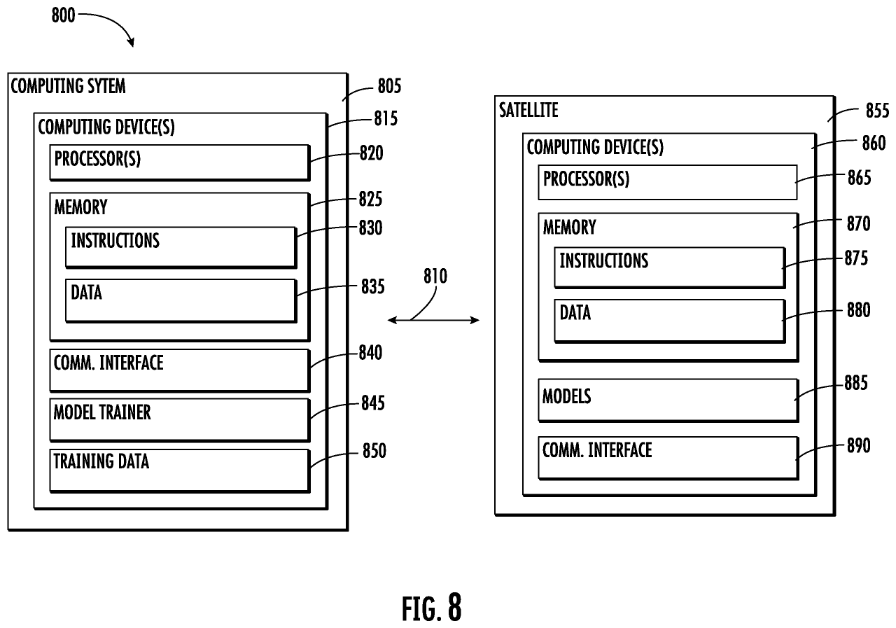

FIG. 8 depicts an example computing system 800 that may be used to implement the methods and systems according to example aspects of the present disclosure. The system 800 may include computing system 805 (e.g., ground station) and satellite 855 (e.g., satellite system 100), which may communicate with one another using transmission signals 810 (e.g., radio frequency transmissions). The system 800 may be implemented using a client-server architecture and/or other suitable architectures.

The computing system 805 may include one or more computing device(s) 815. Computing device(s) 815 may include one or more processor(s) 820 and one or more memory device(s) 825. Computing device(s) 815 may also include a communication interface 840 used to communicate with satellite 855 and/or another computing system/device. Communication interface 840 may include any suitable components for communicating with satellite 855 and/or another system/device, including for example, transmitters, receivers, ports, controllers, antennas, or other suitable components.

Processor(s) 820 may include any suitable processing device, such as a microprocessor, microcontroller, integrated circuit, logic device, or other suitable processing device. Memory device(s) 825 may include one or more computer-readable media, including, but not limited to, non-transitory computer-readable media, RAM, ROM, hard drives, flash drives, or other memory devices. Memory device(s) 825 may store information accessible by processor(s) 820, including computer-readable instructions 830 that may be executed by processor(s) 820. Instructions 830 may be any set of instructions that when executed by processor(s) 820, cause one or more processor(s) 820 to perform operations. For instance, execution of instructions 830 may cause processor(s) 820 to perform any of the operations and/or functions for which computing device(s) 915 and/or computing system 805 are configured (e.g., such as the functions of a satellite ground station, GEO hub, etc.). In some implementations, execution of instructions 830 may cause processor(s) 820 to perform, at least a portion of, methods 700 according to example embodiments of the present disclosure.

As shown in FIG. 8, memory device(s) 825 may also store data 835 that may be retrieved, manipulated, created, or stored by processor(s) 820. Data 835 may include, for instance, any other data and/or information described herein. Data 835 may be stored in one or more database(s). The one or more database(s) may be connected to computing device(s) 815 by a high bandwidth LAN or WAN, or may also be connected to computing device(s) 815 through various other suitable networks. The one or more databases may be split up so that they are located in multiple locales.

The computing system 805 may include a model trainer 845 that trains the machine-learned models 885 stored at the satellite 855 using various training or learning techniques. For example, the machine-learned models 885 may be trained using a loss function. By way of example, for training a cloud avoidance model, the model trainer 845 may use a loss function. For example, a loss function may be backpropagated through the machine-learned models 885 to update one or more parameters of the machine-learned models 885 (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

The model trainer 845 may train the machine-learned models 885 (e.g., cloud avoidance model) in an unsupervised fashion. As such, the machine-learned models 885 may be effectively trained using unlabeled data for particular applications or problem domains, which improves performance and adaptability of the machine-learned models 885.

The computing system 805 may modify parameters of the machine-learned models 885 (e.g., the cloud avoidance model 302) based on the loss function such that the machine-learned models 885 may be effectively trained for specific applications in an unsupervised manner without labeled data.

The model trainer 845 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 845 may perform a number of generalization techniques (e.g., weight decays, dropouts, etc.) to improve the generalization capability of a model being trained. In particular, the model trainer 845 may train the machine-learned models 885 based on a set of training data 850.

The training data 850 may include unlabeled training data for training in an unsupervised fashion. In an example, the training data 850 may include unlabeled sets of data indicative of cloud formations, snow/ice covered land, sea foam, etc. The training data 850 may be specific to satellite or constellation of satellites to help focus the machine-learned models 885 on a particular orbital pattern.

In an embodiment, training examples may be provided by the satellite 855 (e.g., satellite system 100). Thus, in such implementations, a model 885 provided to the satellite 855 may be trained by the computing system 805 in a manner to personalize the model 885.

The model trainer 845 may include computer logic utilized to provide desired functionality. The model trainer 845 may be implemented in hardware, firmware, and/or software controlling a general-purpose processor. For example, in an embodiment, the model trainer 845 may include program files stored on a storage device, loaded into a memory and executed by one or more processors. In other implementations, the model trainer 845 may include one or more sets of computer-executable instructions that are stored in a tangible computer-readable storage medium such as RAM, hard disk, or optical or magnetic media.

Computing system 805 may exchange data with satellite 855 using signals 810. Although one satellite 855 is illustrated in FIG. 8, any number of satellites may be configured to communicate with the computing system 805. In some implementations, satellite 855 may be associated with any suitable type of satellite system, including satellites, mini-satellites, micro-satellites, nano-satellites, etc. Satellite 855 may correspond to any of the satellites described herein (e.g., satellite system 100.).

Satellite 855 may include computing device(s) 860, which may include one or more processor(s) 865 and one or more memory device(s) 870. Processor(s) 865 may include one or more central processing units (CPUs), graphical processing units (GPUs), and/or other types of processors. Memory device(s) 870 may include one or more computer-readable media and may store information accessible by processor(s) 865, including instructions 875 that may be executed by processor(s) 865. For instance, memory device(s) 870 may store instructions 875 for implementing a command receive and image collect for capture image data; storing image data, commands, tracks, etc.; transmitting the image data to a remote computing device (e.g., computing system 805). In some implementations, execution of instructions 875 may cause processor(s) 865 to perform any of the operations and/or functions for which satellite 100 is configured. In some implementations, execution of instructions 875 may cause processor(s) 865 to perform, at least a portion of, method 700.

Memory device(s) 870 may also store data 880 that may be retrieved, manipulated, created, or stored by processor(s) 865. Data 880 may include, for instance, image acquisition commands, tracks, sequences, position data, data associated with the satellite, image data, and/or any other data and/or information described herein. Data 880 may be stored in one or more database(s). The one or more database(s) may be connected to computing device(s) 860 by a high bandwidth LAN or WAN, or may also be connected to computing device(s) 860 through various other suitable networks. The one or more database(s) may be split up so that they are located in multiple locales.

In an embodiment, the satellite 855 may store or include one or more machine-learned models 885. For example, the machine-learned models 885 may be or may otherwise include various machine-learned models. In an embodiment, the machine-learned models 885 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

In an embodiment, the one or more machine-learned models 885 may be received from the computing system 805 via one or more signals 810, stored in the satellite 855 (e.g., memory 870), and then used or otherwise implemented by the processors 865. In an embodiment, the satellite 855 may implement multiple parallel instances of a single model.

Additionally, or alternatively, one or more machine-learned models 885 may be included in or otherwise stored and implemented by the computing system 805 that communicates with the satellite 855 according to a client-server relationship. For example, the machine-learned models 885 may be implemented by the computing system 805 as a portion of GEO communication infrastructure. Thus, one or more models 885 may be stored and implemented at the satellite 855 and/or one or more models 885 may be stored and implemented at the computing system 805.

Satellite 855 may also include a communication interface 890 used to communicate with one or more remote computing device(s) (e.g., computing system 805, geostationary satellite(s), etc.) using signals 810. Communication interface 890 may include any suitable components for interfacing with one or more remote computing device(s), including for example, transmitters, receivers, ports, controllers, antennas, or other suitable components.

In some implementations, one or more aspect(s) of communication among the components of system 800 may involve communication through a network. In such implementations, the network may be any type of communications network, such as a local area network (e.g. intranet), wide area network (e.g. Internet), cellular network, or some combination thereof. The network may also include a direct connection, for instance, between one or more of the components. In general, communication through the network may be carried via a network interface using any type of wired and/or wireless connection, using a variety of communication protocols (e.g. TCP/IP, HTTP. SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

Furthermore, computing tasks discussed herein as being performed at a server may instead be performed at a user device. Likewise, computing tasks discussed herein as being performed at the user device may instead be performed at the server.

While the present subject matter has been described in detail with respect to specific example embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system of a satellite comprising:
one or more sensors comprising a forward-looking sensor;
one or more processors; and
one or more tangible, non-transitory, computer-readable media storing instructions executable by the one or more processors to cause the computing system to perform operations, the operations comprising:
obtaining image data from the forward-looking sensor of the satellite, wherein the satellite is traveling along a current trajectory;
determining, using a model and based on the image data, an imaging target and cloud coverage associated with the imaging target;
determining a comparison between the cloud coverage associated with the imaging target and a threshold level of cloud coverage;
determining an updated trajectory for the satellite based on the current trajectory and the comparison between the cloud coverage associated with the imaging target and the threshold level of cloud coverage; and
generating one or more command instructions to control a motion of the satellite based on the updated trajectory.

2. The computing system of claim 1, wherein the operations further comprise accessing metadata associated with one or more environmental conditions.

3. The computing system of claim 2, wherein the metadata comprises at least one of (i) a sensor temperature, (ii) a sun angle, (iii) an earth surface angle, or (iv) a slew angle.

4. The computing system of claim 1, wherein the operations further comprise receiving a request for imagery of a geographic region, the request for imagery associated with the imaging target and the threshold level of cloud coverage.

5. The computing system of claim 1, wherein the operations further comprise:
determining, based on the current trajectory, a probability of the satellite passing over the imaging target; and
determining an updated imaging target based on the probability.

6. The computing system of claim 1, wherein the model is a convolutional neural network.

7. The computing system of claim 1, wherein the one or more sensors comprises at least one of (i) a VIS camera (ii), or (ii) a LWIR camera.

8. The computing system of claim 1, wherein the updated trajectory is a slew trajectory.

9. A computer-implemented method comprising:
obtaining image data from one or more sensors of a satellite comprising a forward-looking sensor, wherein the satellite is traveling along a current trajectory;
determining, using a model and based on the image data, an imaging target and cloud coverage associated with the imaging target;
determining a comparison between the cloud coverage associated with the imaging target a threshold level of cloud coverage;
determining an updated trajectory for the satellite based on the current trajectory and the comparison between the cloud coverage associated with the imaging target and the threshold level of cloud coverage; and
generating one or more command instructions to control a motion of the satellite based on the updated trajectory.

10. The computer-implemented method of claim 9 further comprising accessing metadata associated with one or more environmental conditions.

11. The computer-implemented method of claim 10, wherein the metadata comprises at least one of (i) a sensor temperature, (ii) a sun angle, (iii) an earth surface angle, or (iv) a slew angle.

12. The computer-implemented method of claim 9, further comprising receiving a request for imagery of a geographic region, the request for imagery associated with the imaging target and the threshold level of cloud coverage.

13. The computer-implemented method of claim 9, further comprising:
determining, based on the current trajectory, a probability of the satellite passing over the imaging target; and
determining an updated imaging target based on the probability.

14. The computer-implemented method of claim 9 further comprising:
controlling the motion of the satellite to pass over the imaging target, wherein passing over the imaging target is indicative of a nadir position or an off-nadir position; and
obtaining, using a sensor of the one or more sensors, imagery of the imaging target.

15. The computer-implemented method of claim 10, wherein the model is a convolutional neural network.

16. The computer-implemented method of claim 10, wherein the one or more sensors comprises at least one of (i) a VIS camera (ii), or (ii) a LWIR camera.

17. The computer-implemented method of claim 10, wherein the updated trajectory is a slew trajectory.

18. A non-transitory computer-readable media storing instructions that are executable by one or more processors to cause the one or more processors to perform operations, the operations comprising:
obtaining image data from a forward-looking sensor of a satellite, wherein the satellite is traveling along a current trajectory;
determining, using a model and based on the image data, an imaging target and cloud coverage associated with the imaging target;
determining a comparison between the cloud coverage associated with the imaging target a threshold level of cloud coverage; and
determining an updated trajectory for the satellite based on the current trajectory and the comparison between the cloud coverage associated with the imaging target and the threshold level of cloud coverage; and
generating one or more command instructions to control a motion of the satellite based on the updated trajectory.

19. A computer-implemented method comprising:
obtaining image data from a forward-looking sensor of a satellite;
determining, using a model and based on the image data, an imaging target and cloud coverage associated with the imaging target, comprising:
analyzing, using the model, an image frame of the image data;
generating, using the model, a plurality of image segments, wherein the plurality of image segments is associated with one or more clouds depicted in the image frame;
generating, using the model, a plurality of blurred image segments, wherein the plurality of blurred image segments are indicative of cloud characteristics; and
determining, using the model, the cloud coverage associated with respective blurred image segments of the plurality of blurred image segments.

20. The computer-implemented method of claim 19, further comprising:
determining a comparison between the cloud coverage associated with the imaging target a threshold level of cloud coverage; and
determining an updated trajectory for the satellite based on a current trajectory and the comparison between the cloud coverage associated with the imaging target and the threshold level of cloud coverage.
